(19) United States
(12) Patent Application Publication
(10) Pub. No.: US 2025/0309679 A1
(43) Pub. Date: Oct. 2, 2025

(54) Intelligent Nanogrid Adapted Appliance System

(71) Applicant: Pila Energy, Inc., San Francisco, CA (US)

(72) Inventors: Cole Ashman, San Francisco, CA (US); Aleksandar Daniel Oleg Rivin, Westminster, CO (US)

(21) Appl. No.: 19/083,668

(22) Filed: Mar. 19, 2025

Related U.S. Application Data
(60) Provisional application No. 63/569,986, filed on Mar. 26, 2024.
(60) Provisional application No. 63/680,432, filed on Aug. 7, 2024.
(60) Provisional application No. 63/683,114, filed on Aug. 14, 2024.
(60) Provisional application No. 63/689,550, filed on Aug. 30, 2024.

(51) Int. Cl. H02J 9/06; H02J 3/14; H02J 3/38; H02J 7/00; H02J 7/02; H02J 13/00

(52) U.S. Cl. CPC H02J 9/062; H02J 3/14; H02J 3/388; H02J 7/0068; H02J 7/02; H02J 13/00001; H02J 13/00022; H02J 2300/24; H02J 2310/14

(57) ABSTRACT

A backup power system comprises a power supply input, a battery, a plurality of power outputs, a processing unit, and an enclosure that includes the battery and the processing unit and at least partially includes the power supply input and the plurality of power outputs. The power supply input is configured to receive AC power distributed via an electrical system of a building. The processing unit is configured to selectively provide power to the plurality of power outputs from the battery or the power supply input based on a status of the received AC power.

This application claims the benefit of:
U.S. provisional patent application No. 63/569,986, filed on Mar. 26, 2024;
U.S. provisional patent application No. 63/680,432, filed on Aug. 7, 2024;
U.S. provisional patent application No. 63/683,114, filed on Aug. 14, 2024; and
U.S. provisional patent application No. 63/689,550, filed on Aug. 30, 2024;

The disclosures of each of the above-referenced provisional applications are incorporated by reference herein in their entireties.

### FIELD

The present disclosure relates to systems and techniques for power generation and energy storage at a premises, and more specifically, to an Intelligent Nanogrid Adapted Appliance System.

### BACKGROUND

The landscape of backup power solutions for residential settings comprises various technologies attempting to address power interruptions. Traditional backup systems such as uninterruptible power supplies (UPS) offer short-term backup at low power output but lack the intelligence necessary to manage energy to connected devices during outages, for remote monitoring, or for deeper software-enabled integration with the devices they power and with broader home energy and solar product ecosystems.

Whole-home battery systems, illustrated by products such as Tesla's Powerwall, provide comprehensive general-purpose home backup but are hindered by high costs, complex installation that requires rewiring, inaccessibility for renters due to permitting and fixed installation requirements, and do not offer any deeper data insight into the home appliances they power. Similarly, fixed-in-place fossil fuel generators lack networked software intelligence and often face environmental restrictions and entail significant fixed installation and maintenance overhead hindering mass adoption.

Portable fossil fuel generators also lack intelligence such as the aforementioned solutions, pose safety risks, require manual operation, and do not align with evolving environmental and health regulations.

Portable battery power stations are designed for supplying general-purpose AC and DC power on-the-go. However, they are not optimized for home backup use as they require manual operation, running of temporary extension cords, and have form factors which are inconvenient for persistent installation. However, these systems also lack the intelligence to support nanogrid functionality alongside household appliances, or to offer additional energy management, control and monitoring to the devices they power, or to support stability of the larger power grid via advanced software control systems.

While some electric vehicles (EVs) show promise for providing residential backup power, their use presents practical challenges such as complex home electrical system integration and rewiring, manual backup initiation, potential unavailability during an outage, and lack of appliance-level insight.

Additionally, conventional household appliances themselves lack intelligent power management and monitoring or embedded energy storage, leading to users being unaware of performance anomalies until appliances fail or experience significantly degraded performance. Given the long lifespan of most major home appliances, the barrier of replacement for modern technology presents significant challenges to access better solutions.

Home energy monitoring equipment and home energy management systems (HEMS) boast some improvements over backup power solutions alone when the two are paired together, however these systems suffer the same limited data as whole-home backup battery systems, relying primarily on power monitoring to inaccurately infer downstream appliance presence, performance, and status. Moreover, these solutions require permitting and specialized labor, creating major barriers to scale.

### BRIEF DESCRIPTION OF THE DRAWINGS

Some embodiments of the present disclosure are illustrated as an example and are not limited by the figures of the accompanying drawings, in which like references may indicate similar elements and in which:

FIG. 1 depicts a system level block diagram showing functional elements of a NAAS and relational groupings.

FIG. 2 is a flow chart describing an example of software functions executed by a NAAS.

FIG. 3 depicts an example of several modules and connections on the IoT module printed circuit board assembly of a NAAS, including the main compute microcontroller.

FIG. 4 depicts an example of circuitry including aspects of the logic power circuit architecture and AC voltage sensing circuitry of the NAAS, with respect to the islanding capabilities enabled by the grid disconnect relay.

FIGS. 5a, 5b and 5e depict three front facing isometric views of an illustrative design embodiment, highlighting functional mechanical aspects and external user interfaces for power, indication, and other user interactions.

FIGS. 5c, 5d and 5f depict three rear facing isometric views, of an illustrative design embodiment, highlighting functional mechanical aspects and external user interfaces for power, indication, and other user interactions.

FIG. 6 depicts a view of an embodiment of the system highlighting the use of mounting functions of a remote unit.

FIGS. 7a and 7b depict examples of a system co-located with the primary associated AC appliance, highlighting features supporting ease of connecting power and signal connections.

FIG. 8a shows a design of the system for installation in a nearby cabinet.

FIGS. 8b and 8c show designs of the system, for installation atop various designs of refrigeration appliances.

FIG. 8d shows a design of the system, for installation proximate to a chest-style refrigerator or freezer.

FIG. 9a details a power architecture with a main unit hosting energy storage, bidirectional DCAC power conversion, grid disconnects, and power relays along with a connected remote unit hosting additional receptacles that are controllable and energy monitored, and allowing for connection of external DC source and energy storage modules.

FIG. 9b shows a related architecture in which DC optimization functionality for connected sources and energy storage exists within the main unit, along with a plurality of metered, controllable receptacles on the main unit.

FIG. 9c shows a related architecture wherein both AC and DC power conductors are passed from a main unit to remote unit.

FIG. 9d shows an alternate approach to achieve similar functionality with two independent DCAC conversion stages and a power relay configuration to switch AC loads between sources.

FIG. 9e details a simplified power architecture variation wherein a bidirectional DCAC within a main unit is connected to a plurality of receptacles connected to a shared DC bus.

FIG. 9f details a related power architecture design wherein a switching bypass relay is used to manage connection of the plurality of AC receptacles to the DCAC and input source, independent of the DCAC main grid disconnect relay.

FIG. 10 depicts a logic state diagram of an example of the Nanogrid Control System software's intentional islanding behavior.

FIGS. 11a and 11b depict logic state diagrams of an example of the Energy Management System software's Energy Saving mode for embodiments in which the primary associated appliance is a refrigerator/freezer.

FIG. 11a details illustrative logic when internal temperature and door state sensing via environmental sensors is available.

FIG. 11b details illustrative logic when environmental sensors are not used.

FIG. 12 provides an example of time-series power and temperature data comparing baseline performance to Energy Savings mode performance, for embodiments in which the primary associated appliance is a refrigerator/freezer.

FIG. 13 depicts a logic state diagram of an example of the Appliance Management System software's performance and state abnormality detection.

FIG. 14a shows an example of software-implemented logic when AC-coupled onsite solar is available.

FIG. 14b shows an example of software-implemented logic when both AC-coupled and DC-coupled solar are available.

FIG. 15 is a flow chart of the Nanogrid Control System software's microgrid coordination software functions.

FIG. 16 illustrates several examples of how the system can be designed for direct mechanical and electrical coupling with select appliances, such as a refrigerator and washer-dryer appliance.

FIG. 17 depicts a more detailed view of an example of a design of the system for direct mechanical and electrical coupling with select appliances.

FIG. 18 depicts an example of a connectorized wiring harness system between the system and an appliance designed for coupling, highlighting a manner of connection between AC connection points and communication and control wiring points.

FIG. 19 is a flow chart illustrating an example of a process that may be performed by the system to provide AC power to a connected appliance.

### DETAILED DESCRIPTION

The current state of residential backup power solutions and home appliances leaves a need for cost-effective, intelligent, and easily deployable backup power and context-aware, programmable energy management solutions. These solutions should seamlessly integrate with essential household appliances, ensuring reliable backup power supply and granular, application-specific sensing to provide valuable appliance performance monitoring.

The present disclosure, therefore, is directed toward enhancing energy resilience, energy awareness, appliance performance, and safety within residential environments through the use of an intelligent Nanogrid Adapted Appliance System (NAAS) and/or a system of multiple interconnected NAASs (the term “nanogrid” is defined below). A NAAS such as described below monitors and safeguards critical devices providing reliable power to resources such as food and medicine refrigeration, communication devices, space conditioning, home security equipment, and other essential home devices in the event of power disruptions or other abnormal operation. A NAAS designed to provide backup power supply to essential household devices during grid outages, catering to the pressing need for reliable, intelligent, and scalable solutions, while simultaneously providing appliance-tailored performance monitoring through any power scenario for improved everyday awareness.

A NAAS represents a departure from traditional fixed and temporary backup power systems and IoT appliances. It introduces all-in-one, self-contained, purpose-built nanogrids for simple pairing with household appliances, transforming existing appliances into intelligent, interconnected power nodes capable of autonomous energy optimization, detection of performance anomalies, and automatic backup power. Without requiring professional installation, yet with advanced software intelligence and smart-home/smart-grid integration capability, the approach introduced here promises unprecedented accessibility, resilience, adaptability, and device-specific performance insights for critical appliances.

Innovations in energy storage and intelligent power management are pivotal for maintaining safety, communication, comfort, and convenience during power loss and abnormal operation, as well as stabilizing the power grid at-large. The disclosed system introduces a pioneering approach by integrating purpose-built integrated nanogrid systems alongside existing household appliances. This transformative integration empowers conventional devices and appliances to become digitally independent, interconnected, intelligent power nodes capable of self-powering during outages and actively participating in the larger electric power system.

The field of the present disclosure converges at the intersection of battery energy storage, household appliances, intelligent monitoring, Internet of Things (IoT), and decentralized energy management. This system seeks to bridge the gap between existing general purpose backup power solutions and the growing demand for accessible, cost-effective, and automated home systems. A NAAS seamlessly adapts to various appliance classes and manufacturers without complex installation processes and without specialized labor.

This disclosure addresses the limitations of traditional backup systems such as uninterruptible power supplies (UPS), portable generators, and permanent grid-tied solutions (such as stationary backup generators and whole-home solar backup battery systems) as well as limitations of traditional and modern home appliances. NAAS introduces a versatile and scalable system to empower homeowners and renters with reliable backup power and intelligent appliance-level performance awareness.

The NAAS approach is designed to enhance household energy resilience during power outages and provide unprecedented awareness into essential appliance performance. The system includes a battery energy storage module and power conversion and control system, which seamlessly integrates with various household appliances to provide reliable power to a primary associated appliance while also providing auxiliary power to other portable electronic devices. Engineered for user-friendly installation and operation, the NAAS system incorporates intelligent software-defined appliance energy management, unprecedented environmental sensing capabilities, and a power conversion and control architecture. This system empowers users with home power management and smart energy insights representing a significant advancement in accessibility to home backup power solutions. As an example, in some embodiments a NAAS can be designed to be installed alongside a refrigerator/freezer in minutes by an average home occupant to provide unprecedented user awareness of refrigeration appliance performance, and therefore increase safety of refrigerated food and medicines. By networking NAAS systems together, we introduce the concept of Nanogrid Distributed Energy Resources (N-DERs) for intelligent integration and interoperability to expand the granular control capabilities of the utility grid and home microgrid.

In this disclosure, a distinction is drawn between a microgrid and a nanogrid. A “microgrid” is defined herein as a premises wiring system that includes power generation, energy storage and one or more loads, and includes the ability to disconnect (i.e., to intentionally “island”) from and to operate in parallel with the primary source. Microgrids contain some or all of the premises distribution system (e.g., load centers and feeder conductors) to provide broad coverage of the electrical system. As such, a microgrid necessarily contains fixed-in-place (i.e. non-temporary) electrical equipment subject to specific installation and permitting requirements. For a residential microgrid, the primary source is generally considered to be the electric utility grid.

In contrast, a “nanogrid” is defined herein as a self-contained system, designed for operation at a premises (e.g., a home or small business), that may be electrically connected in either a temporary or non-temporary manner and that includes energy storage, connection points for generation, and connection points for one or more loads, and includes the ability to disconnect from and operate in parallel with the premises wiring system (i.e., with the utility grid). A nanogrid has the ability to operate within a microgrid, Hence, one or more nanogrids can exist as nested elements within a premises' microgrid system, or may exist in the absence of a larger microgrid system such that all intentional islanding capabilities across the site are limited to each independent nanogrid.

The intelligent NAAS redefines smart home technologies and battery backup resiliency solutions with its purpose-built design for simple, plug-and-play integration alongside target existing appliances, providing substantial technical improvements over conventional home backup power solutions, home appliances, and home energy management systems. By including advanced software plus computation architecture, the technology offers continuous monitoring of environmental variables and power consumption to provide unprecedented context into performance of essential household appliances such as refrigeration, space conditioning, and communication. Additionally, this system provides automatic, seamless backup power and energy management for connected appliances via its internal battery energy storage system and power conversion modules offering peace of mind from power outages and appliance performance abnormalities. The system, scalable and adaptable, introduces unprecedented software features targeting performance optimization, energy management, nanogrid controls, and appliance failure prediction algorithms. The system boasts user-friendly interfaces both onboard and through companion smartphone and web applications for monitoring even while users are away from home. Furthermore, the system's design positions it to actively participate within a broader home energy ecosystem and microgrid, with APIs for seamless interoperability. The system supports flexible use, with AC and DC power receptacles for powering multiple plug-in devices, and connections for additional user-installable modules to expand hardware-enabled capabilities over time. The approach introduced here surpasses traditional fixed-in-place home microgrid systems in simplicity, accessibility, and appliance context-awareness while also surpassing traditional portable backup systems in safety, software intelligence, integration capabilities, and scalability. This system thereby provides an affordable, scalable, smart solution to monitor and power the most essential home devices.

### High-Level Product Architecture and Application

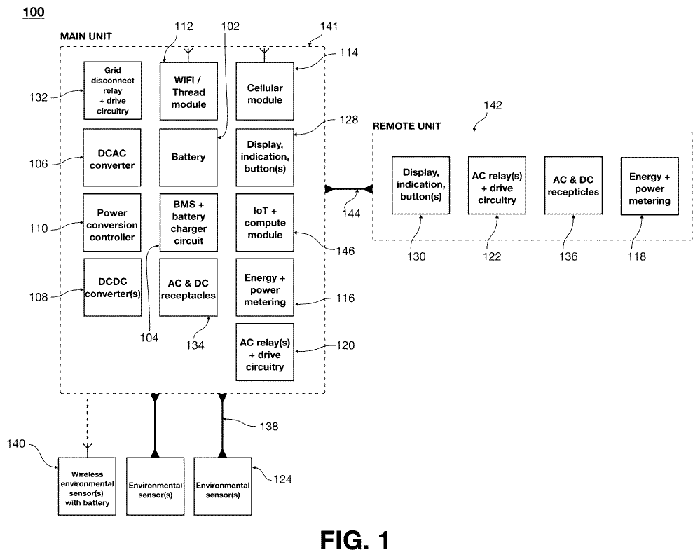

FIG. 1 illustrates an example of a NAAS, according to at least one embodiment. The NAAS (also called “the backup power system” or simply “the system” herein) 100 includes a device that encompasses an integrated battery energy storage system 102 and battery management system (BMS) 104, one or more alternating current (AC) power conversion and direct current (DC) power conversion mechanisms 106-110, one or more onboard compute 108-110 and communication modules 112-114, one or more integrated circuit board assemblies, one or more battery and thermal management units 104, and one or more receptacles, user interfaces, and safety elements. The NAAS system 100 incorporates circuitry for power measurement 116-118 and control of connected devices 120-122, environmental sensors 124, sensor inputs 126, and a user interface for displaying system status 128-130. By using an onboard grid disconnection relay 132, the system is capable of isolating from the supply power (i.e., intentionally islanding from the broader home electrical system or microgrid).

The system 100 is designed to integrate seamlessly with one or more existing household appliances, such as with existing refrigerator/freezer appliances of a variety of styles and manufacturers (e.g. side-by-side, top-freezer, French door, chest-style refrigeration appliances) in some embodiments. The system 100 is designed to connect directly to one or more supported appliances, i.e., with no premises wiring or utility-provided wiring or other infrastructure electrically between the system 100 and the supported appliance(s). Additionally, the system offers general use power output receptacles 134-136 for powering portable devices such as phones, tablets, laptops, rechargeable flashlights, and countertop kitchen appliances. Moreover, other embodiments of the system cater to purpose-designed integration with other primary associated appliances such as:
Internet network routers and personal computer equipment
Security devices (e.g. doorbells, alarms, home security cameras)
Critical lighting fixtures
Semi-permanent heating/cooling units (e.g. fans, window air conditioning units)

Designed for user-friendly installation, this plug-and-play system 100 is engineered for ease, enabling installation by individuals without specialized knowledge of electrical systems. In some embodiments, the system is configured to sit atop a standard refrigerator/freezer appliance or within an adjacent storage cabinet. Although designed for semi-permanence, the system 100 retains user-removability, allowing relocation when needed. Semi-permanent installation may be via a mounting bracket and fasteners for optional wall attachment.

The system 100 receives AC power via connection to an existing home power receptacle. In embodiments targeting refrigerator/freezer applications, that appliance (i.e., the refrigerator/freezer) is plugged into a receptacle or connected to the system 100 such that the appliance may selectively receive power from the system 100 (as determined by software onboard the system 100), from the existing wall outlet as a pass-through (for efficiency, to reduce conversion losses during normal grid-connected modes), or from a combination of both sources.

Environmental sensor modules 124 optionally connected to the system may contain temperature, humidity, proximity, sound, and/or light sensors. In some embodiments, these sensors are designed to measure internal refrigeration/freezer conditions such as temperature and light by transmitting analog signals over a wired connection 138 back to a main unit. These sensor packages are designed for easy user replacement. Other embodiments of environmental sensor packages 140 use wireless integration by including an onboard rechargeable battery and communication modules, and may also use embedded computational capability within the sensor module itself for digital communication to the main unit.

Some embodiments of the NAAS host additional AC power receptacles (e.g., NEMA 5-15R, 1-15R, and/or 5-20R for the North American market) and DC outputs (e.g., USB type A, USB type C, and general purpose 12 volt DC outputs) 134-136. The receptacles 134-136 can be located on the main unit 141, and/or on a user-relocatable remote unit 142 connected to the main unit 141 via data and power cable 144. This versatility enables users to power, monitor, and manage various portable devices as needed. Other embodiments include electrical receptacle styles common globally outside of North America.

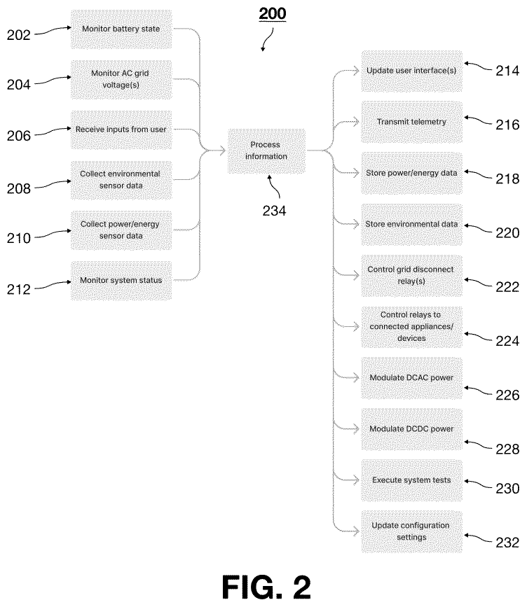

FIG. 2 illustrates an example of the software functions executed by the NAAS, detailing the flow of inputs, processing, and software-defined actions carried out by the system. To enable software intelligence and seamless interoperability, the main unit may integrate an Internet of Things (IoT) compute and communication module 146, designed for broad integration across NAAS systems and nanogrid products. This module facilitates software-enabled functions 200 within the Energy Management System (EMS), Nanogrid Control System (NCS), and Appliance Management System (AMS), as well as connectivity and external communication capabilities.

The system receives multiple inputs that inform its real-time operation and decision-making. It monitors the battery state 202 to assess charge levels, state of health, and readiness to provide backup power. It continuously monitors AC grid voltage(s) 204 to detect fluctuations, outages, or anomalies that may necessitate islanding or other protective actions. The system also incorporates user inputs 206, allowing occupants or administrators to configure preferences, control connected appliances, or manually trigger system functions. Additionally, the system collects environmental sensor data 208, which may include temperature, humidity, air quality, and other relevant metrics affecting system performance. It further gathers power and energy sensor data 210 from internal and external loads, ensuring real-time tracking of consumption, efficiency, and grid interaction. The system also performs continuous monitoring of overall system status 212 to track operational health and detect potential faults.

Upon processing these inputs 234, the system executes a variety of software-defined actions. For example, it updates user interfaces 214, ensuring that real-time data and system insights are accessible through on-device displays, smartphones, and web applications. The system transmits telemetry 216, providing remote monitoring, diagnostics, and integration with cloud services or grid management platforms. It also stores power and energy data 218 for historical analysis and predictive optimization, and stores environmental data 220 to monitor trends that may affect appliance or system performance.

In at least some embodiments, a critical control function of the NAAS is the operation of grid disconnect relays 222, allowing the system to transition between grid-connected and islanded modes based on grid conditions. Additionally, the system controls relays to connected appliances and devices 224, enabling intelligent load management and dynamic power adjustments. To further enhance power management, it modulates DCAC power 226 and modulates DCDC power 228, adjusting energy conversion based on demand, grid conditions, and available stored energy.

For reliability and safety, the system can execute system tests 230, ensuring all components, including batteries, relays, and power electronics, operate within specified parameters. Finally, the system updates configuration settings 232, allowing for dynamic adaptation to changing conditions, user preferences, and software-defined optimization strategies.

Together, these capabilities define a highly adaptable and intelligent nanogrid appliance system, capable of integrating with broader energy ecosystems while providing resilience, efficiency, and automation at the appliance level. Note that some embodiments of the NAAS may not include all of the above-described software functions, and some embodiments may include additional software implemented functions not mentioned above.

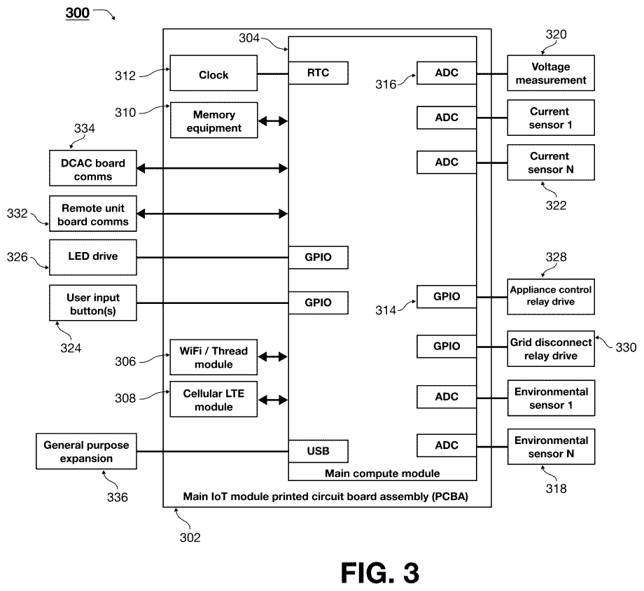

FIG. 3 depicts several modules and connections on a printed circuit board (PCB) assembly implementing an IOT compute and communication module 300 of the NAAS. The IOT compute and communication module 300 may be an implementation of module 146 in FIG. 1. The IOT compute and communication module 300 includes the main processing unit of the NAAS, e.g., the compute microcontroller 304, which controls the high-level functionality of the NAAS. In other embodiments, the main compute microcontroller 304 may be supplemented or replaced by one or more other types(s) of processing unit(s), such as one or more programmable general-purpose microprocessors, application-specific integrated circuits (ASICs), programmable logic devices (PLDs), or the like, or any combination thereof.

The IoT and compute module 300 may be an implementation of the IoT compute and communication module 146 in FIG. 1, and is designed to support integration into various embodiments of a NAAS. This module 300 includes a PCB assembly (PCBA) which hosts a main compute microcontroller 304 to which various PCBA peripherals are connected, such as wireless modules 306-308, non-volatile memory equipment 310, and a real-time clock (RTC) module 312. By incorporating general purpose input/outputs (GPIOs) 314 and analog-to-digital converters (ADCs) 316, the main compute module microcontroller 304 is designed to receive input signals from environmental sensors 318 (such as thermistors and/or photoresistors), AC and DC voltage sensors 320 and current sensors 322 to measure power outputs, and other user inputs such as physical buttons 324. Additionally, the main compute microcontroller 304 is designed to control peripheral circuitry such as light emitting diode(s) (LEDs) indicators 326 and power relays 328-330 for energy management. The main compute microcontroller 304 is designed with various communication channels using protocols such as SPI, I2C, CAN, RS485, and/or USB for digital communication with other elements of the system, such as the remote unit controller 332, the DC-to-AC (DCAC) power converter 334, and general purpose USB peripherals 336.

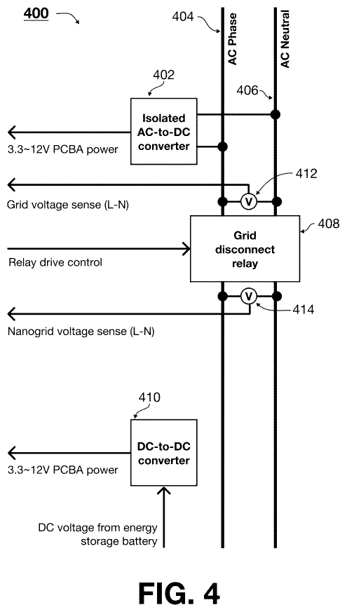

FIG. 4 depicts circuitry 400 including aspects of the logic power circuit architecture and AC voltage sensing circuitry of the NAAS with respect to the islanding capabilities enabled by the grid disconnect relay 408. Logic power to the circuitry 400, including the main compute, IoT modules, and power conversion control circuitry, is selectively supplied by an AC-to-DC converter power supply 402 connected to the AC phase 404 and neutral 406 conductors on the upstream side (i.e. home, microgrid, grid side) of the onboard grid disconnect relay 408 to ensure the system's logic power is up in all instances where it is supplied with AC input power. When AC input power is not available (such as during a home power outage), the system is designed to selectively source logic power from the onboard energy storage battery 410 via a dedicated DC-to-DC converter. The system is designed with AC voltage monitoring on both the upstream 412 and downstream side 414 of the grid disconnect relay to provide a differential signal which may be used to ascertain the AC voltage and frequency of the source input and nanogrid whether the grid disconnect relay is open or closed.

Internet connectivity enables seamless receipt of over-the-air software and firmware updates, facilitating the addition of new software capabilities, thereby ensuring ongoing enhancement and adaptability within the installed application. Beyond software updates, the system integrates flexible power plus data input/output interfaces (e.g. USB) enabling the user to attach new hardware capabilities. In some embodiments targeting refrigerator/freezer applications, examples of such hardware add-ons include home air quality monitoring, communication modules to smart utility meters for comprehensive whole-home energy monitoring, provisions for DC solar photovoltaic inputs enabling solar charging from external solar panels, integration of a cellular LTE module ensuring dependable internet backup during home internet unavailability, and a spectrum of additional enhancements poised for integration.

### Physical and Industrial Design

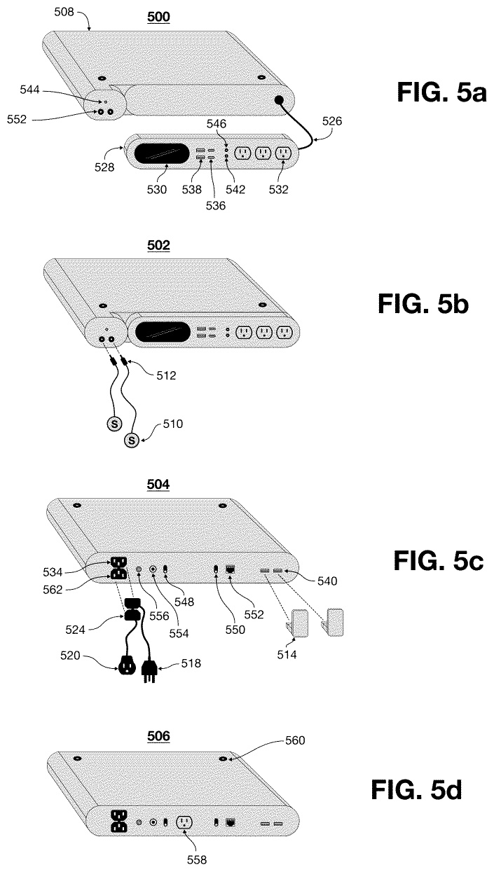

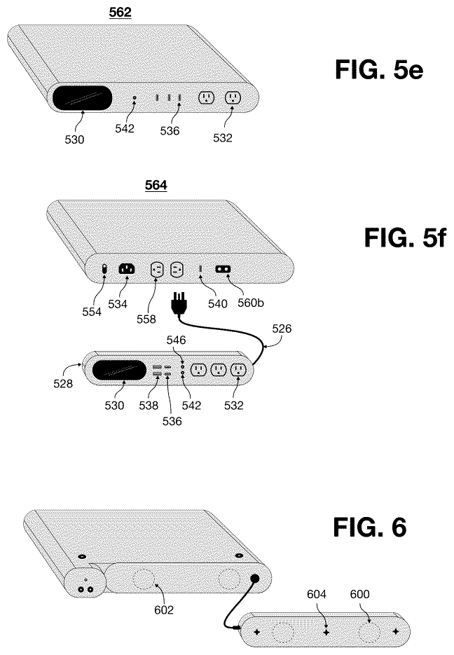

FIGS. 5a through 5f shows front views 500-502, 562 and rear views 504-506, 564 of some embodiments of the present disclosure targeted at refrigeration appliances detailing essential components including the main unit 508, optional environmental sensor package(s) 510-514, AC power cords 518-526, and a remote unit 528. The main unit 508 and remote unit 528 each feature robust enclosures, crafted from polymeric, metallic, or combined materials, housing critical internal components such as the battery module, battery management components, power conversion components, and internal compute and communication modules.

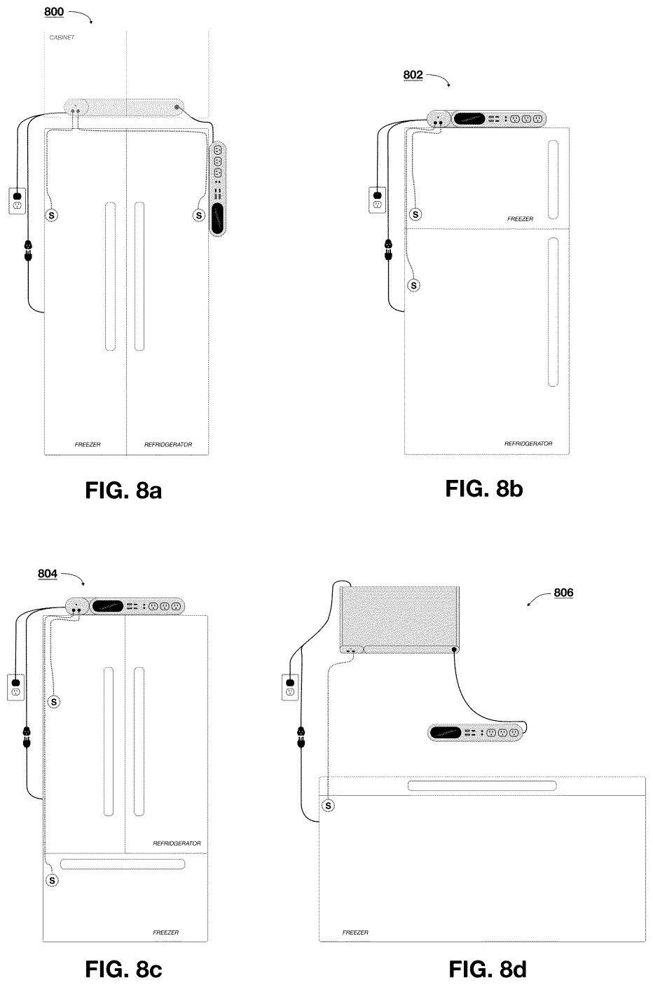

The remote unit 528, a pivotal inclusion considering potential installation in less accessible locations, incorporates a user interface element 530 (e.g., display screen) and user-accessible power receptacles 532-540. The remote unit 528 may be mechanically affixed to the main unit 508 as shown in FIG. 5b, magnetically attached to the appliance (e.g., a refrigerator), secured to a wall, or otherwise positioned on and/or attached to surfaces such as kitchen counters, as illustrated by FIG. 8. Offering power receptacles (AC and DC) and user interface elements—such as LED indicators 542, a digital display, operational mode adjustment buttons 544, speakers, and environmental lighting—the remote unit is designed to blend aesthetically with the surrounding environment.

A wired connection links the remote unit to the main unit 526, ensuring full user replaceability for effortless installation and service. This integrated cable includes power and data conductors—AC conductors (Line, Neutral, Ground) for the receptacles onboard the remote unit, serial data conductors (e.g., SPI, USB, CAN, or RS485) for communication and control of onboard user interfaces, and a DC conductor pair for logic power supply to user interfaces, compute on the remote unit, and low voltage DC receptacles (such as USB type A and USB type C) 536-538. In some embodiments, DC conductor pair(s) may be omitted in favor of an additional AC-to-DC converter contained within the remote unit.

In some embodiments, the remote unit integrates environmental sensors—temperature, humidity, air quality, and/or ambient light—dedicated to measuring ambient conditions near connected appliances. The optional environmental sensor units, when of a wired connection design 512, connect to accessible input jacks 552 located on the main unit or remote unit. Additionally, some embodiments of the system include accessible general use power plus data receptacles 540 (e.g. USB) for the user to retrofit other sensors and radio modules 514 to extend functionality after installation.

The system incorporates status indication mechanisms, combining LED indicators 542-544 and/or a screen 530. This display conveys diverse device statuses, including power states, operational modes, errors, grid status, battery charge level, power and energy consumption metrics, instantaneous power data (watts, volt-amperes, power factor, volts, current, frequency), energy statistics (watt-hours, volt-ampere-hours), temperature readings, environmental sensor outputs, internet connection status, wireless module connections, and estimated backup power duration.

User-accessible buttons and switches are integrated to execute various functions—power control, ground fault circuit interruption (GFCI) test and reset 546, software reset, adjustment of LED and display settings—available on both the main and remote units in different embodiments. In some embodiments, a user-accessible interface to the overcurrent protection for the main AC input 554 is provided, which may be of a resettable thermal-magnetic style or cartridge fuse receptacle style.

In some embodiments, the system incorporates an onboard user-accessible switch 548 to set a maximum continuous charge and/or discharge currents, aligning with common outlet and breaker specifications (e.g., 12 or 16A continuous for 15 or 20A outlet and breaker, respectively, which are common ratings for residential circuit-level protection in North America).

Additionally, in some embodiments the system includes a switch to deactivate wireless internet connectivity 550 for users opting for an offline device usage, as well as an Ethernet RJ-45 port 552 for wired connection to the home LAN to supplement WiFi connectivity.

The system includes various touch-safe external electrical ports/connectors (e.g., plugs and/or receptables) to connect the system to the grid/microgrid and to one or more supported appliances. For example, in some embodiments such as shown in FIG. 5a, to connect the system to the home's AC electrical system (i.e. the line, neutral, and protective earth or ground AC conductors), a wired cable and connector assembly is provided for connection to a standard wall AC receptacle using an AC plug 518 connected via an electrical cable to a touch-safe plug 524 which plugs into a receptacle 534 on the main unit. In some embodiments, the system supports an additional cable and connector assembly with a standard AC receptacle 520 to connect a target appliance to the main unit via an additional dedicated AC receptacle 562 that is electrically connected to the nanogrid side of the system's AC power system. In some embodiments of the disclosure, standard AC receptacle(s) are included on the main unit 558 for convenience and flexibility in connecting appliances. To facilitate maintenance, power cords 518-526 are designed in a detachable format, featuring connectors such as IEC connector style, NEMA receptacle style, USB style, or other customized power and data connectors for service replacement. In some embodiments, a grounding screw terminal 556 is provided on the main unit for connection to the Protective Earthing (PE) system when the building's AC receptacles do not provide a ground (PE) prong.

In some embodiments, a pair of touch-safe electrical ports 560a-560b used for connection of additional DC battery pack(s) and/or solar MPPT input are disposed on the exterior of the system's enclosure, including at least positive and negative terminals. All of the power ports/terminals/connectors mentioned in this description can be said to be at least partially “included in” the system's enclosure to the extent they each protrude from a surface of the enclosure or are positioned within an opening in a surface of the enclosure.

In some embodiments, as shown in FIG. 6, the remote unit is equipped with features to assist with simple mounting of the remote unit to the main unit, to a magnetic surface, or to another non-magnetic surface. Some embodiments achieve this using permanent magnet(s) embedded in the remote unit 600 or in the remote unit and main unit 602, of sufficient strength to balance sturdy attachment with user removability. Some embodiments of the remote unit incorporate features 604 for mechanically interfacing with a post or wall-inserted fastener to facilitate fixing the remote unit to a non-magnetic surface such as a wall.

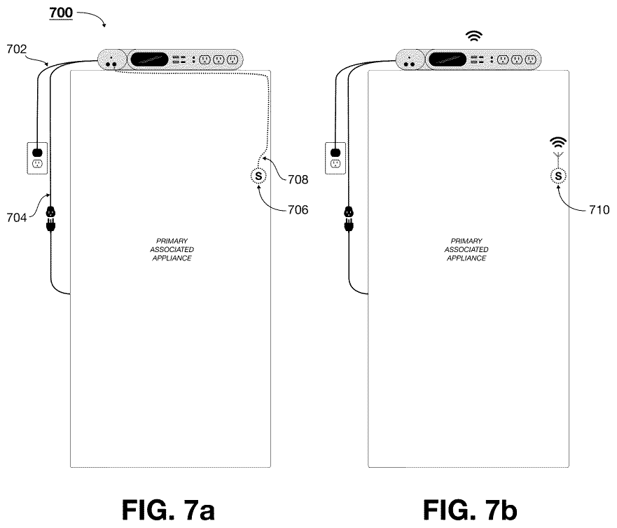

The system is designed for user-friendly installation enabling installation by individuals without specialized expertise. This can be achieved using aforementioned simple plug-in connectors for the system, as shown by the example in FIGS. 7a and 7b. FIGS. 7a and 7b depict a system co-located with the primary associated AC appliance, highlighting features supporting ease of connecting power and signal connections. The AC power input to the system is supplied by a cord and plug 702 connected to a standard home AC receptacle. The AC connection from the system to a primary associated appliance may be provided via a cord and receptacle 704 to avoid the need for general use AC extension cords between this appliance and the system, as well as to allow flexible location of the system's remote unit untethered to the AC power cord of a primary associated appliance. The optional wired environmental sensors are designed for similar ease of use with wired sensors 706 connected via unobtrusive cables and connectors 708 to the main unit. Environmental sensors of a wireless design 710 similarly enable ease of installation and offer an unobtrusive design.

In some embodiments targeting refrigerator/freezer applications, the system is designed for flexibly locating the main unit proximate to the appliance, and for simple user-installed connections for AC supply power, AC power to the appliance, and optional environmental sensors, as shown by example in FIGS. 8a through 8d. This includes optimization of size, weight, center of gravity, and form for mounting on top of a refrigerator/freezer 802-804 of various styles (e.g., side-by-side, top-freezer, French door, chest-style), optimization for mounting in a cabinet near the appliance 800, or wall-mounting 806. In each of these considered applications, the remote unit may be mechanically attached to the main unit, to a magnetic surface (e.g., the metallic body of the appliance), or to a non-magnetic surface (e.g., a wall) based on the user's preference for access.

### Power and Energy Specifications and Architecture

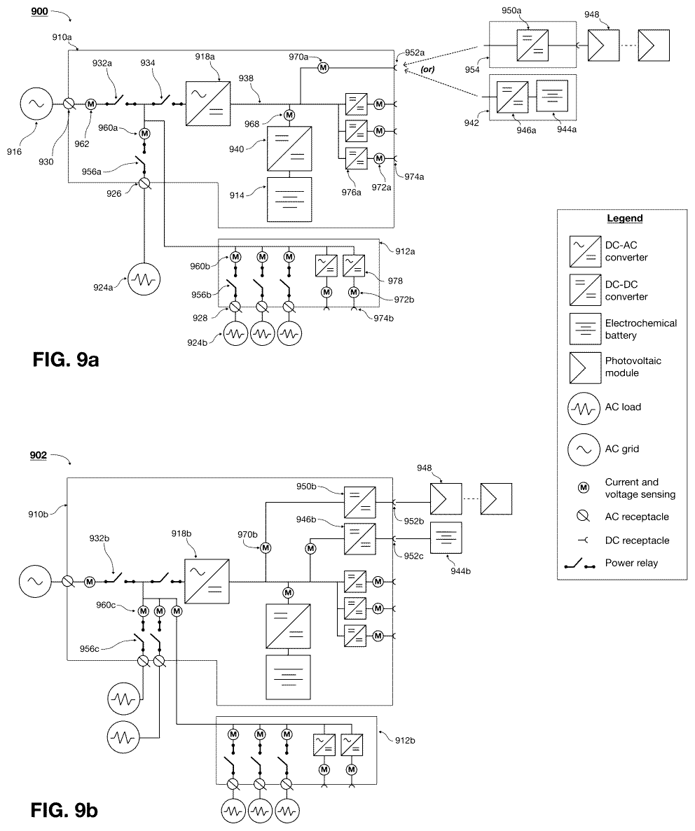

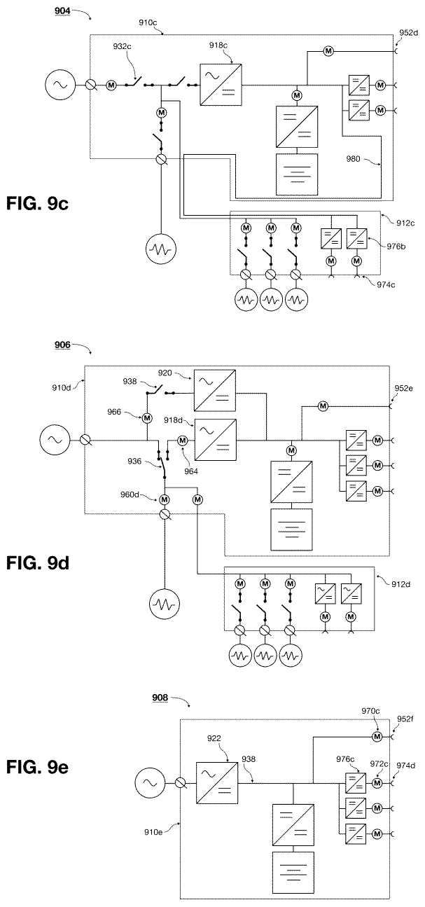

The power architecture design of the system allows for flexible, software-defined modes of supplying power to connected appliances and devices, charging or discharging the onboard storage battery, and/or sourcing or sinking power to connected add-on power modules. Depending on the embodiment and driven by the intended type of primary associated appliance, the system's power architecture can have any of various forms, such as architectures 900-908 and 978 in FIGS. 9a-9f which utilize common elements distributed between the main unit 910a-f and remote unit 912a-d.

The main unit 910a hosts a rechargeable battery pack 914, such as Lithium-ion cells, for bulk energy storage and serving as a primary source to power the system itself and connected devices in the event of an outage of grid/microgrid power 916. This battery's capacity is designed to maintain a manageable weight and size, facilitating easy installation in close proximity to the appliance. Additionally, the battery's capacity is tailored to provide several hours or more of backup power to protect against severe power outages. In some embodiments targeting refrigerator/freezer applications, the main unit battery usable energy capacity is between 1-3.5 kilowatt-hours (kWh). Battery capacity may vary across different embodiments to suit each specific appliance-integration application, and may be supplemented by add-on battery module(s) 942, 944b; 980.

The main unit 910a-d; 910f includes a main DC-to-AC (DCAC) power converter (also called simply “DCAC”) 918a-d, respectively, capable of converting DC power from nanogrid sources (such as the onboard battery and/or connected DC sources such as external solar photovoltaic panels) to AC power connected appliances 924a-b, 924f via the onboard AC output receptacles 926-928. In some embodiments' designs illustrated by 900-904, the main DCAC 918a-d is capable of operating in parallel with the voltage source connected to its AC power input 930 via the home AC receptacle, allowing for optional power export to the home and/or home microgrid. In some embodiments of units 900-904, the main DCAC 918a-d is bidirectional (i.e. designed to route current and convert power in both directions: AC-to-DC and DC-to-AC) to achieve also efficient charging of the onboard storage battery 914. The bidirectional main DCAC 918a-d is also designed as a “hybrid” inverter (sometimes referred to as ‘multimode’ design) which can operate in both grid-forming (voltage-forming) and grid-following (voltage-following current source) modes.

Isolation of the bidirectional hybrid main DCAC output from the main AC input for intentional islanding and safety purposes is managed by a software-controllable grid disconnect relay (power relay) 932a-c, 932f. An additional software-controlled AC relay 934 enables the AC power connected appliances 924a-b, 924f to be connected to the output of the main DCAC when power is unavailable from the grid AC input and adds redundancy for AC isolation between the main DCAC and grid AC input. AC relays may be of a single-pole/single-throw (SPST) design to disconnect the line conductor, or double-pole/single-throw (DPST) design to simultaneously disconnect line and neutral conductors.

In some embodiments, illustrated by FIG. 9d, a power architecture for equivalent functionality 906 is used wherein one DCAC converter 918d is used to source AC voltage to supply connected AC loads, and an additional DCAC converter 920 is used to convert AC voltage to DC voltage to support the intermediate DC bus (e.g., to charge the onboard battery from home/grid power). In such embodiments a SPDT or DPDT relay 936 is used to switch the line, or line and neutral conductors, respectively, of connected AC loads between the main AC input (i.e. home/grid AC) or the onboard DCAC output. This architecture allows efficient power of AC appliances during normal grid-connected operation by minimizing power conversion steps. In some embodiments of the NAAS, illustrated by FIG. 9f, an AC load bypass switch 982 is used to optionally shift the AC load connection between either side of the DCAC's onboard grid disconnect relay 932f. This design ensures connected AC loads can receive power from the nanogrid's AC input connection (e.g. from a wall receptacle) even under scenarios where the DCAC onboard grid disconnect relay remains open (e.g. due to a fault scenario).

To power connected AC appliances, the main DCAC 918a-d is capable of generating AC output voltage replicating the premises' grid/microgrid voltages. In North American residences this is nominally 110-120 AC volts root-mean-squared (V RMS), and in other global markets it is 230-240 VAC RMS. In embodiments targeting refrigerator/freezer applications, the main DCAC outputs single-phase power (e.g. 110-120 VAC L-N, 230-240 VAC L-N) to match the AC input of a refrigeration appliance. However, other embodiments use a DCAC designed to supply split-phase AC power (e.g. 120/240 VAC L-N-L) with appropriate power receptacles for this output voltage. In some embodiments the bidirectional DCAC is designed to have a full-bridge, half-bridge, H-bridge, or multilevel converter topology. The DCDC converter(s) may be of an isolated, non-isolated, resonant, boost, or boost-buck topology design. DCAC and DCDC power conversion circuitry uses solid state switching technology, with some embodiments utilizing one or a combination of Silicon Carbide (SiC) MOSFET or IGBT technology.

The AC power architecture is designed for optimal efficiency in powering appliances connected to the system. Connected appliances are supplied with power from the AC current generated by the system's DCAC in either a grid-following mode or grid-forming mode during outages or to minimize power draw from the grid/microgrid. These appliances can also be supplied directly from the grid's AC current without passing through power conversion, to minimize conversion losses during normal grid connected operation. These appliances can also be supplied from a combination of both grid current and current from the DCAC in a grid-following mode. Notably, the design allows for simultaneous operation of appliances and charging of the onboard battery, showcasing the efficiency and dual functionality embedded within the internal AC power architecture. More, in the event of a device failure impeding energy management or nanogrid control functions such as backup power, the power architecture is designed to automatically ensure AC appliances and loads receive power from the utility grid source via the position of internal power relays and reserve capacitive energy storage to drive these relays, ensuring uninterrupted operation of connected AC appliances.

The main DCAC's power output is designed to accommodate the running-load-amps (RLA) of the primary associated appliance plus additional power capacity for user-connected devices. The DCAC's power conversion controls are adept at managing inrush current during turn-on of inductive loads (e.g., compressors, motors) without causing overloading of the battery or power conversion circuitry. The power output adheres to residential circuit and receptacle standards, for example, in embodiments targeting refrigerator/freezer applications providing between 1500-2400 watts continuous AC output power with short-duration surge capacity of 3600-7800 watts.

The system includes a DC bus architecture designed to support flexibility of connected DC sources, enabling users to add-on DC power modules. The power architecture includes a common intermediate DC bus 938 on which a variable number of DC sources can connect in parallel to exchange DC power and connect with the DC input to the main DCAC. In some embodiments, DC sources include the onboard battery 914 and its bidirectional DCDC 940, external DC battery pack(s) and their bidirectional DCDC 946a-b to increase the energy storage capacity of the nanogrid, and/or solar photovoltaic (PV) modules 948 and an associated boost DCDC 950a-b, 950f. In some embodiments for cost optimization of the main unit, solar PV module(s) are designed to connect to the main unit's common DC bus by means of an external converter 954 to perform DC boost and maximum power point tracking (MPPT) thus providing a regulated DC input into the main unit. In other embodiments for user simplicity, the main unit hosts onboard solar PV MPPT DCDC power conversion 950b such that a simple solar panel, or string of solar panels, 948 between 12-48 V DC may be user-connected without need for external solar power conversion modules. Similarly, the power architecture to support add-on battery storage may be designed either to host a bidirectional DCDC 946b onboard the main unit to which an external low voltage battery and BMS 944b, 944f may be connected, or an add-on battery storage module 942, 980 may be designed encompassing a BMS plus battery 944a, and bidirectional DCDC converter 946a. DCDCs capable of sourcing current onto the common intermediate DC bus are designed to operate via voltage droop coordination or via a high-speed digital communication link (e.g., CAN or other serial communication to DCDC controllers) to achieve a common output voltage on the common intermediate bus. Connection of external DC sources is made by dedicated DC connector receptacles 952a-g on the main unit.

Battery charging and discharge rate is controlled by onboard Energy Management System (EMS) and Battery Management System (BMS) software, which interact with onboard Appliance Management System (AMS) and Nanogrid Control System (NCS) software.

The AC power architecture is designed for optimal awareness and management of connected appliances. To enable power and energy management, the power architecture incorporates power metering at various points to generate a complete and accurate picture of energy use, including voltage (V), frequency (Hz), current (A), real power and energy (W, Wh), apparent power and energy (VA, Vah), and reactive power and energy (VAr, VArh). For the purposes of current sensing, the system uses one or a combination of sensor technologies such as inductive current transformers (CTs), shunts, or hall-effect sensors. The AC receptacles are designed to monitor power using dedicated current sensors 960a-d, 960f for each receptacle, to provide the system and user information about consumption of these AC appliances. In some embodiments, the main AC input is metered 962 for accurate measurements of total power and energy import and export from the device to the home/microgrid. In some embodiments, the system directly meters the AC output power from the main DCAC 964 and AC input to the charger DCAC 966 for similar purposes of constructing complete and accurate AC power flows.

The system similarly is designed to meter power and energy of DC nodes to facilitate building a complete view of power flow throughout the NAAS. DC metering locations include metering of the input/output of the main storage battery 968, metering of input/output of add-on DC sources 970a-c, 970f, and metering 972a-c, 972f of DC device power receptacles 974a-d, 974f. In some embodiments, the system infers DC power consumption via USB-PD circuitry without need for additional dedicated voltage and current sensing for these receptacles.

To enable the power and management features within the NAAS and its connected devices, software-controllable AC relays 956a-c, 956f allow the system to selectively route power at the granularity of each AC receptacle, or group of AC receptacles 926-928 supplying power to downstream appliances and devices. Power management to user-connected DC devices is similarly capable via the system's power architecture, such as by incorporating DCDC converters 976a-c, 976f and DCAC converters 978 to selectively manage voltage and current delivery on DC device power receptacles. In some embodiments, such a DCDC or DCAC converter (i.e. rectifier) is dedicated to each DC device power receptacle for maximum granularity of control, while other embodiments incorporate multiple DC device power receptacles per converter. In some embodiments, further efficiency is achieved by avoiding DCAC rectifiers supplying DC device power receptacles, by ensuring all DC device power receptacles are supplied via a DCDC converter connected to the common intermediate bus. For example, this may be achieved by a DC conductor pair 980 routed to a remote unit that is sized for appropriate current carrying capacity for DC device power receptacles on the remote unit.

The system prioritizes safety as a foundational element of its design. Embedded within the battery system are robust safety mechanisms ensuring safe operation and compliance with stringent industry standards. Multiple layers of protection, including hardware and software overcurrent protection (such as via a combination of fuse(s), thermal fuse(s), resettable thermal-magnetic circuit breaker(s), and active software current monitoring), temperature monitoring, and short-circuit prevention, mitigate potential hazards or risks associated with battery operation. Furthermore, compliance with industry standards and regulations is integral to the system's design. Stringent adherence to safety certifications and standards ensures the system's reliability, safety, and compatibility with established industry benchmarks. Rigorous testing and adherence to safety protocols have been integrated into the system's development process, ensuring user safety and peace of mind. These safety mechanisms and compliance measures collectively underscore the NAAS system's commitment to safe and reliable operation, adhering to industry best practices and ensuring user safety at its core.

To further enhance user safety, in embodiments targeting refrigerator/freezer applications, AC outlets 928 are equipped with Ground Fault Circuit Interrupter (GFCI), also known as a Residual Current Detector (RCD) protection following industry best practices to minimize risk of electric shock to persons in wet locations such as kitchens. The GFCI feature includes a user-friendly indication 542 and reset interface 546, conveniently located on accessible components such as the remote unit. Additionally, the unit incorporates circuitry and logic to detect its grounding status (i.e. connection of the protective earth conductor to the main AC input), ensuring grounding safety measures are maintained in both grid-connected and grid-disconnected states.

### Backup Power and Nanogrid Intentional Islanding

The system is capable of seamlessly delivering backup power during grid power outages and protecting against potential grid anomalies (e.g. sustained overvoltage and under-voltage) that may pose performance and longevity risks to connected essential appliances. The system continuously monitors the grid's AC voltage and frequency at its AC power input 930 connected to the home power receptacle, ensuring prompt and autonomous response to any power disturbances.

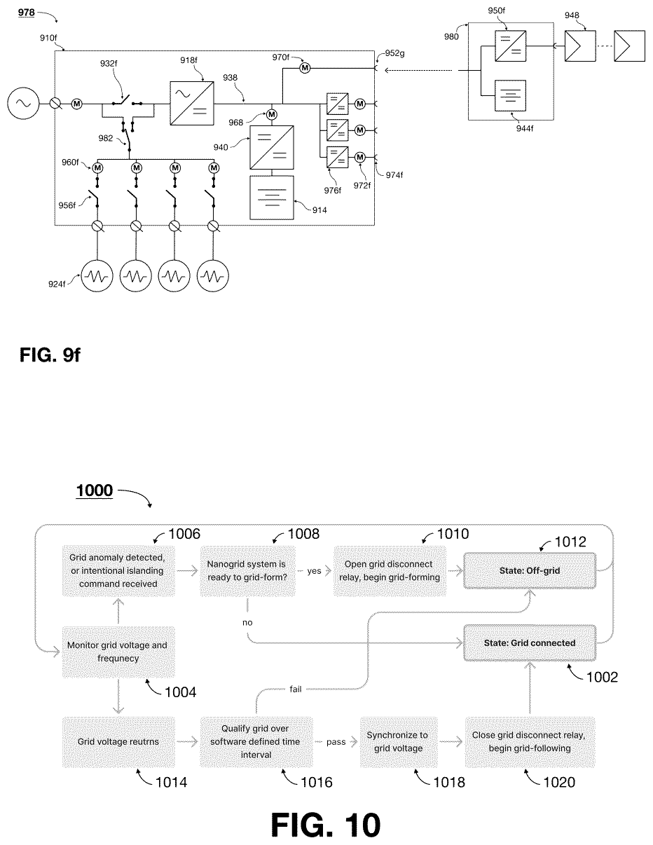

Grid disconnection and reconnection are software-controlled, allowing adjustable logic for timing and sensitivity to disturbances through software programming. An example of a logic flow 1000 for implementing such software control is shown in FIG. 10. The system continuously monitors grid voltage and frequency 1004 at its AC input, ensuring real-time awareness of grid conditions. If the system detects a grid anomaly or receives an intentional islanding command 1006, it evaluates whether the nanogrid system is ready to grid-form 1008. If the system is determined to be ready to grid-form, it opens the grid disconnect relay and begins grid-forming 1010, transitioning into the off-grid state 1012, in which the system supplies power independently from its onboard energy storage and generation resources.

If the system is not ready to grid-form at 1008, it remains in the grid-connected state 1002, continuing to monitor grid conditions. Once the grid voltage is restored 1014, the system enters a requalification phase where it qualifies the grid over a software-defined time interval 1016. If the grid fails to meet the required stability criteria, the system remains in an off-grid state. However, if the grid conditions pass the qualification test, the system proceeds to synchronize to grid voltage 1018, ensuring a smooth transition back to grid operation.

After synchronization, the system closes the grid disconnect relay and begins grid-following 1020, transitioning back to the grid-connected state 1002. This logic ensures safe and automatic reconnection to the utility grid while maintaining continuous power delivery to essential appliances.

Upon grid disconnection, the system engages a grid-forming (voltage-forming) mode, supplying seamless backup power to its AC output receptacles 926-928 while also maintaining power on DC outputs 974a-d, 974f, ensuring continued operation of critical devices. The nanogrid's Energy Management System (EMS) actively manages power during backup, limiting power to preserve battery energy and constraining total power draw within set limits. This intelligent transition between grid-tied and off-grid operation ensures resilience, energy stability, and enhanced control over backup power availability.

The system offers software-controllable AC power relays 956a-c and software-controllable DC outputs 976a-c to manage connected loads, allowing selectively stopping power output to specific receptacles or reducing power to DC outlets via USB Power Delivery (USB-PD) control. AC power relays may be of solid state or electromechanical design in various embodiments. When the onboard battery reaches a critical low state of energy, the system safeguards against over-discharge by ceasing power delivery to receptacles and shutting down non-essential peripherals.

Upon detecting the return of grid/microgrid voltage, the system monitors and qualifies the voltage and frequency conditions before seamlessly and automatically reconnecting by closing the grid disconnect relay.

To maintain sufficient stored battery energy for backup power, the system allows users to define a reserve level of battery State of Energy (SOE). This reserve ensures that a predetermined percentage of battery capacity remains dedicated to backup power. Onboard intelligence allows the system to alert users of outage scenarios through onboard indicators and companion smartphone and web applications. This combination of hardware and software intelligence enables the system to deliver reliable and user-friendly backup power functionality.

### Energy Saving Functionality for Refrigeration Appliances

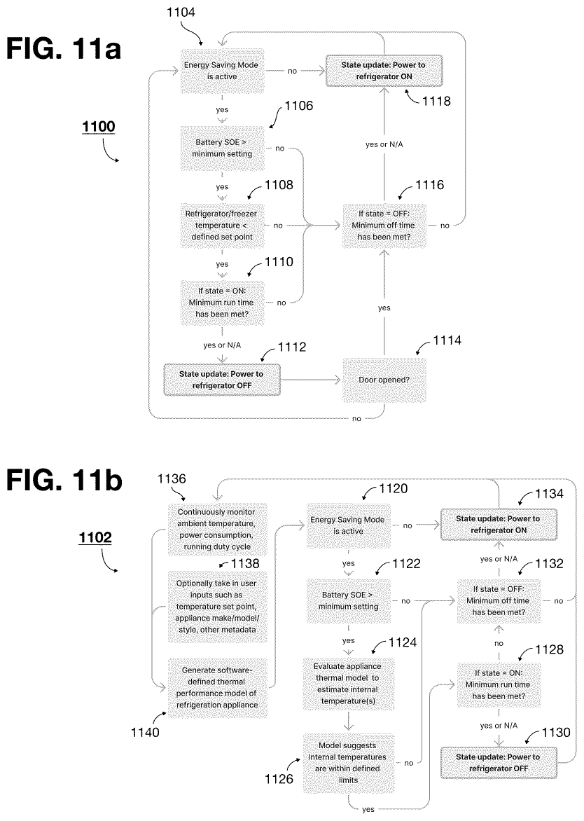

In some embodiments designed to pair alongside a refrigerator/freezer appliance with optional user-installed environmental sensors for monitoring internal temperature and door-state, the system includes Energy Saving functionality. This functionality can operate through software logic 1100-1102 to continuously monitor appliance conditions and optimize power delivery using active controls. An example of the Energy Saving functionality for refrigeration appliances, as shown in FIGS. 11a and 11b, is designed to reduce the energy consumption of the refrigeration appliance below its typical baseline, aiming to extend the battery backup duration during power outages and to optimize energy cost while grid-connected, while striving to maintain temperature internal to the refrigerator and/or freezer within specified limits. This mode can be user-set via onboard interface or companion applications.

FIG. 11a describes a logic flow 1100 where the system first considers whether Energy Saving Mode is set to active 1104. If Energy Saving Mode is not set to active, the system maintains delivery of power to the refrigeration appliances 1118, such as through power relay control or direct communication with the appliance. If Energy Saving Mode is active, the system continuously checks whether the battery state of energy (SOE) is greater than a software-defined minimum setting 1106. If the battery SOE is insufficient, the system maintains delivery of power to the refrigeration appliances 1118. Otherwise, the system checks if the refrigerator or freezer temperature is below a defined set point 1108. If the refrigerator or freezer temperature is not below the defined set point, power to the appliance remains on. If the temperature is below the set point, the system further checks whether the refrigerator has met its minimum run time 1110 when in the ON state. If the minimum run time has been met, the system limits power to the refrigeration appliance 1112, such as by opening a software-controlled power relay, thereby reducing energy consumption to preserve battery charge level. If the minimum run time has not been met, power remains on to prevent short-cycling of compressors. If power to the refrigerator is OFF, the system checks if the minimum OFF time has been met 1116. If the minimum OFF time has not yet been met, power remains OFF. If the minimum OFF time has been met, the system evaluates whether the refrigerator door(s) have been opened 1114. If the door has been opened, power is restored to maintain cooling performance and power active user interfaces of the appliance such as internal lighting and control panels. While the door(s) remains closed, the system repeats the evaluation cycle, waiting to restore power to the connected refrigeration appliance until one of the battery SOE, temperature set point, mode settings, minimum on/off timers, or door state(s) have changed.

FIG. 11b expands on the system's ability to intelligently manage refrigeration loads without requiring external environmental sensors 1102, according to at least some embodiments. The system continuously monitors ambient temperature, power consumption, and running duty cycle 1136, developing and refining a software model for how the appliance operates under various conditions. Additionally, it can take in user inputs such as temperature set points, appliance make and model, and other metadata 1138 to refine its operation. This data is used to generate a software-defined thermal performance model of the refrigeration appliance 1140, allowing the system to predict its behavior. If Energy Saving Mode is active 1120, the system evaluates whether the battery SOE is above the minimum setting 1122. If the battery SOE is not above the minimum setting, the system maintains delivery of power to the refrigeration appliances 1134. If the battery SOE is sufficient, the system proceeds to evaluate the appliance's thermal model to estimate internal temperatures 1124. If the model suggests that internal temperatures remain within defined limits 1126, the system continues energy-saving operation (i.e. limiting power delivery to the appliance). If the temperatures are outside the limits, the system restores power to maintain normal cooling performance. The system then follows a sequence similar to FIG. 11a, ensuring the refrigerator remains powered OFF when appropriate by checking if the minimum OFF time has been met 1132 and evaluating whether the minimum run time has been met 1128 when the state is ON. If the minimum run time has been satisfied, the system updates the state to power the refrigerator OFF 1130, extending battery runtime and optimizing energy use.

By dynamically managing power delivery to refrigeration appliances, the system provides extended battery backup duration while maintaining food safety and efficient operation. The ability to intelligently monitor energy consumption, environmental conditions, and user-defined parameters allows the system to integrate seamlessly within a broader energy management strategy, reducing costs and improving energy efficiency.

To implement this functionality, the system relies on real-time awareness of the connected refrigeration appliance. Utilizing a combination of sensors directly measuring appliance power consumption, temperature internal and/or external to the refrigerator/freezer, light illuminance sensor(s), and other environmental sensors, the system constructs a dynamic software model based on pre-programmed heuristics and learned patterns specific to each connected refrigeration appliance. The control logic then employs various strategies to reduce power draw, including selectively isolating input power to the refrigeration appliance, modulating output AC voltage/frequency of the DCAC converter 918a-d, 918f, and engaging direct digital communication with IoT-enabled refrigeration appliances to enter a manufacturer-defined lower power mode, pause the compressor, reduce compressor speed, and/or skip active defrost cycles. In embodiments targeting refrigeration appliances, Energy Saving software logic 1100 is included and designed to operate effectively when the optional external environmental sensors are used, and Energy Saving software logic 1102 is included and designed to operate when environmental sensors are not present and only power monitoring is available.

Power disconnection to the refrigeration appliance is executed through a dedicated onboard AC relay 926, selectively turning off the connected refrigeration appliance while still optionally providing power to other AC and DC receptacles 928, 974a-d, 974f. During the energy-saving mode, the system automatically restores power 1206 if temperature 1202 inside the refrigerator/freezer exceeds a defined limit or when user interaction is detected.

In embodiments of a NAAS paired with a refrigeration appliance, user presence or interaction with the refrigeration appliance is inferred by the system through a combination of temperature, light, door state, and/or proximity sensors connected to the system, facilitating automatic power restoration. To optimize appliance integration, the system's onboard software can be programmed to follow “minimum off time” heuristics to allow pressure equalization within the refrigeration loop, and/or “minimum run time” heuristics for the connected appliance as part of energy management algorithms.

In certain embodiments, the system includes a user-configurable hardware interface, such as a user-accessible dry contact style control relay input which may be user-connected to a refrigeration appliance's serviceable control circuitry. When utilized, this control interface and control method allow the refrigerator/freezer to skip or delay automatic defrost cycles, achieving more nuanced power and energy reductions without fully powering off the refrigeration appliance. This innovative Energy Saving functionality enhances the overall efficiency and adaptability of the system in conjunction with refrigeration appliances.

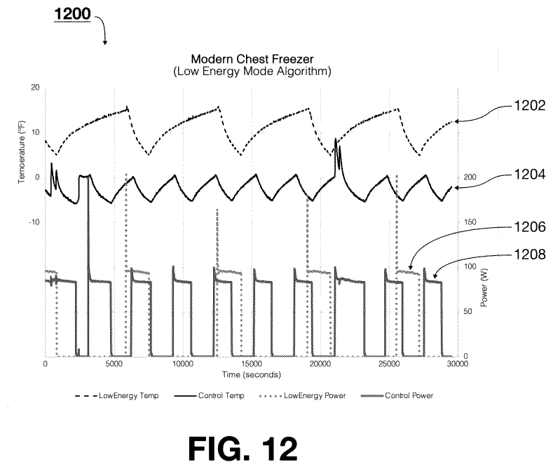

FIG. 12 illustrates an example of the operation of the system in the Energy Savings mode wherein internal freezer temperature is temporarily allowed to rise to 15 degrees Fahrenheit 1202 above the native freezer setpoint of 0 degrees Fahrenheit 1206. Once temperature reaches the Energy Savings maximum setpoint, power is restored to the appliance to allow it to cool the internal temperature to 5 degrees Fahrenheit, thus achieving lower energy consumption primarily by increasing the effective duty cycle 1206 of the refrigeration componentry compared to the baseline always-powered duty cycle 1208.

### Communication and Interoperability

The NAAS system not only provides enhanced power and energy management but also offers comprehensive connectivity features, making it an integral component of smart home ecosystems. The system provides versatile connectivity options designed to ensure seamless integration within smart home and Internet of Things (IoT) ecosystems. By using built-in IEEE 802.11 Wi-Fi connectivity (2.4 GHz and 5 GHz), for example, the device establishes a connection to the home local area network (LAN) internet while concurrently serving as a Wi-Fi access point. This dual functionality enables direct smartphone/tablet connectivity for monitoring, control, and setup purposes. In some embodiments, Bluetooth may complement the connectivity options offering an alternative direct connection method for proximate smartphone/tablet interaction. In some embodiments, the system includes an onboard Thread radio for participation within a home Thread mesh network for communication with one or more NAAS and IoT devices within the home for increased awareness of the home ecosystem.

For remote user monitoring and control, the system interfaces with a dedicated smartphone/tablet application or facilitates access via a web browser on the home LAN. In some embodiments the system includes integrated (or supports add-on) modules to support additional wireless technologies such as IEEE 802.15 Zigbee (for interaction with Distributed Energy Resources (DERs), IoT devices, and/or utility smart meters), IEEE 802.15.4 Thread (for communication with other IoT and smart home devices), or cellular (for internet connectivity in the absence of home Wi-Fi/LAN).

The IoT compute and communication module includes local control capabilities, incorporating an API designed for seamless data exchange with various home energy management systems (HEMS), smart home platforms, and microgrid control systems (MCS). Furthermore, the system's advanced features enable intelligent utilization of nanogrid capabilities (comprising energy storage, power conversion, and load management) to provide support to the wider home microgrid and utility grid. This functionality encompasses configurable “smart inverter features” to maintain microgrid/grid stability, responding to either direct power measurements or external commands, such as frequency-watt control for dynamic adjustment of power consumption/export or reactive power compensation based on voltage and frequency measurements, thereby supporting grid stability.

For added appliance insight, the system includes the capability to communicate directly to smart appliances to offer additional appliance insight via appliance operating status and/or direct measurement from the appliance itself, such as power and temperature signals. The system is designed to offer common smart appliance IoT communication methods such as Wi-Fi and Matter, as well as emergent standards such as CTA-2045 and Matter.

### Other Software-Defined Features

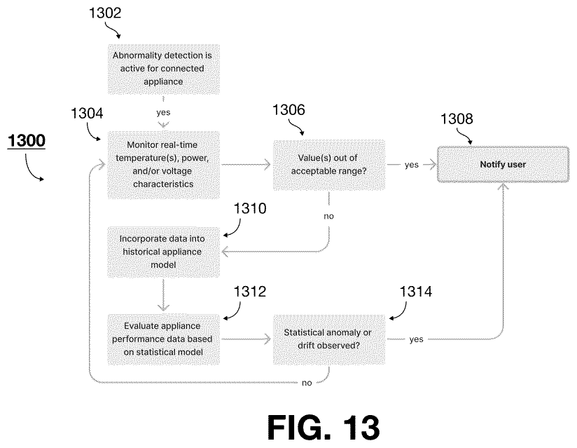

FIG. 13 illustrates an example of the Early Failure Prediction Algorithm 1300, which can be implemented by the Appliance Management System (AMS) to continuously monitor appliance health and detect potential failures before they occur. This process leverages real-time sensor data, historical appliance performance models, and statistical analysis to assess deviations in appliance behavior, and provides users with valuable performance data and insights in real time and as historical data. These algorithms, incorporating lightweight Machine Learning (ML) and statistical analysis techniques, proactively and continually assess appliance health, alerting users to potential risks of failure before any complete or partial malfunction occurs.

The process begins when abnormality detection is active for a connected appliance 1302, enabling continuous monitoring of performance metrics. The system then monitors real-time temperature(s), power, and voltage characteristics 1304 to detect any deviations from expected operating conditions. If the system identifies that any value(s) are out of the acceptable range 1306, it notifies the user 1308, alerting them to a potential issue. This notification may be sent through a connected user interface, such as a mobile application, email or web dashboard, and/or via the on-device user interface (e.g. the display screen).

If no immediate anomalies are detected, the system incorporates the collected data into a historical appliance model 1310 stored on the nanogrid system's memory and in the connected cloud software platform, allowing for ongoing refinement of expected appliance behavior. The system then evaluates the appliance's performance data using a statistical model 1312, identifying long-term trends that may indicate wear or degradation. If the system determines that a statistical anomaly or drift has been observed 1314, such as unexpected energy consumption increases, temperature variations, or voltage instabilities, it once again notifies the user 1308 to prompt action before a failure occurs.

The ability to proactively identify potential appliance failures before they occur significantly enhances system reliability and user awareness. This feature enables predictive maintenance, allowing users to take corrective actions before costly breakdowns or energy inefficiencies arise. By continuously refining its statistical models using real-time and historical data, the system ensures high accuracy in detecting abnormal appliance behavior, ultimately extending appliance lifespan and improving energy efficiency.

The Appliance Management System further harnesses real-time environmental sensing data and power data to deliver specific functionalities, including “Door Open Detection” and “High Internal Temperature Detection.” These features ensure users are promptly informed of any issues that could compromise the performance of the connected refrigeration appliance.

The generated insights are presented to users through various channels, including visual or auditory notifications on the system itself, as well as through mobile text messages, email, or the companion smartphone application. In the context of a refrigerator/freezer pairing, these insights might include, for example:
“Has someone left the fridge door open?”
“Is the compressor likely to fail soon?”
“Is the fridge operating less efficiently compared to others?”
“Is there an issue with the defrost cycle?”
“Is there an anomaly with your home wiring, risking property damage?”

The companion smartphone and web application primary function is to allow users to continually monitor the operating status of the system and the status of plugged-in connected appliances, with user-friendly data streams displaying real-time power, temperature, and other environmental sensor data, as well as measurements plotted over user-definable time periods. These applications also allow users to set up and configure the system's settings, connectivity, and to troubleshoot.

The AMS software collaborates with the Energy Management System (EMS) software within the system. Beyond its role in managing connections to the home/microgrid, the EMS software integrates data on power sources and connected plug loads to optimize power usage within the system's nanogrid based on settings and user preferences.

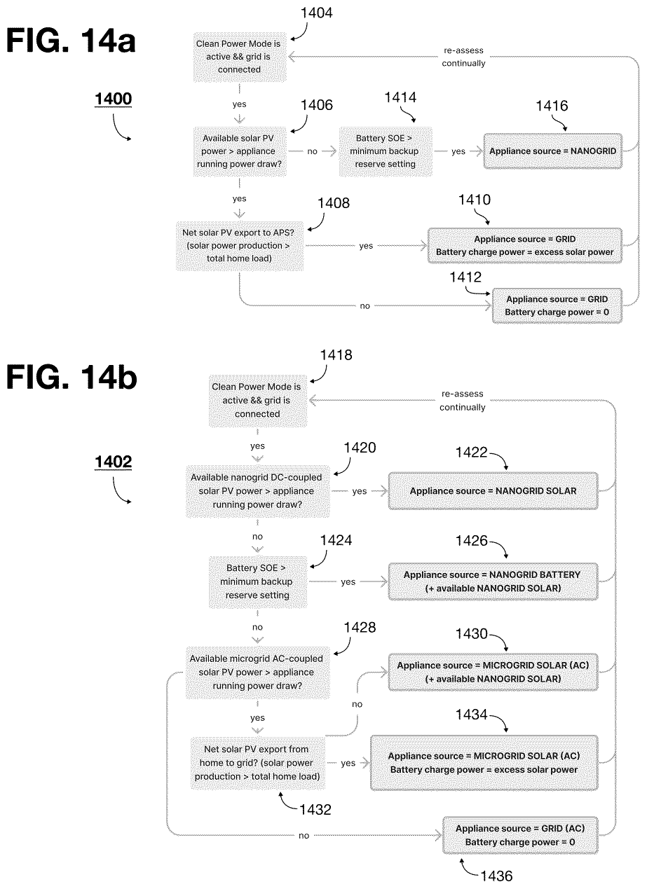

One example of an EMS software feature is the “Clean Power Mode.” In conjunction with onsite solar capabilities, the EMS can be programmed to prioritize the use of onsite (i.e. behind-the-meter) “AC-coupled” solar power (e.g. a fixed rooftop solar system that includes solar photovoltaic panels and inverters or microinverters) and/or direct DC-connected solar PV modules (e.g. connected directly to the NAAS system) to mitigate energy costs from the grid and reduce the carbon impact of refrigeration appliances. FIG. 14a and FIG. 14b illustrate the decision-making process used by the Energy Management System (EMS) to optimize appliance power sourcing and battery charging when Clean Power Mode is active. This mode enables prioritization of cheap, renewable energy sources, including AC-coupled solar power and DC-coupled nanogrid solar power, to reduce dependence on grid electricity and enhance the efficiency of energy storage and appliance operation.

In FIG. 14a, the process 1400 begins when Clean Power Mode is active and the nanogrid is connected to its primary AC power source (i.e. the home's electrical system via a wall receptacle) 1404. The system first checks whether the available AC-coupled solar PV power exceeds the appliance's running power draw 1406. If sufficient solar power is available, the system evaluates whether net solar PV export to the Area Power System (APS), i.e. from the home to the utility grid through the utility meter, is occurring, meaning that total solar production exceeds total home load 1408. If this condition is met, the system actively routes power to supply the appliance from grid power and uses the excess solar power to charge the NAAS battery 1410. If net solar export is not occurring, the appliance continues drawing power from the grid, but battery charging remains disabled 1412. If at 1406 the available solar PV power does not exceed the appliance's demand, the system checks whether the battery state of energy (SOE) is above the minimum backup reserve setting 1414. If the battery has adequate energy reserves, the appliance is supplied by the nanogrid battery 1416; otherwise, power continues to be drawn from the grid. This analysis is continued by the NAAS software system and updated at regular intervals to adjust to changing solar production conditions.

FIG. 14b shows a decision-making process 1402 that includes nanogrid DC-coupled solar power (i.e. directly connected to the nanogrid) and microgrid AC-coupled solar power. When Clean Power Mode is active and the grid is connected 1418, the system first checks if available nanogrid DC-coupled solar power is sufficient to meet the appliance's power demand 1420. If available nanogrid DC-coupled solar power is sufficient to meet the appliance's power demand, the appliance is powered directly by nanogrid solar 1422. If available nanogrid DC-coupled solar power is not sufficient to meet the appliance's power demand, the system checks whether the battery SOE is above the minimum backup reserve setting 1424. If so, the appliance is powered by the nanogrid battery, with any available nanogrid solar contributing as well 1426.

If the battery reserve is insufficient, the system evaluates whether available microgrid AC-coupled solar power can meet the appliance's running power demand 1428. If this condition is met, the appliance is powered by microgrid solar, supplemented by nanogrid solar if available 1430. If the condition in 1428 is not met, the system assesses whether the home is exporting net solar power to the utility grid 1432. If the home is exporting excess solar power, the appliance is powered by microgrid solar, and any excess solar power is used to charge the battery 1434. If no excess solar power is available, the appliance draws power from the grid, and battery charging remains disabled 1436.

This Clean Power Mode logic ensures that the appliance preferentially uses available solar power, optimizes battery charging based on real-time solar production and energy reserves, and reduces reliance on grid electricity, thereby lowering energy costs and carbon footprint. The system continually re-evaluates these conditions to dynamically adjust power sourcing as energy availability changes.

Within a nanogrid as described herein, connected appliances, and DC sources, the EMS undertakes several functions, including battery power dispatch, disaggregated appliance-level power and energy usage monitoring, and grid/microgrid support. The EMS can autonomously respond to voltage, frequency, and power factor measurements at the input AC connection, modifying the performance of the onboard power conversion (e.g., charge/discharge rate) or connecting/disconnecting power to appliances to stabilize the power input.

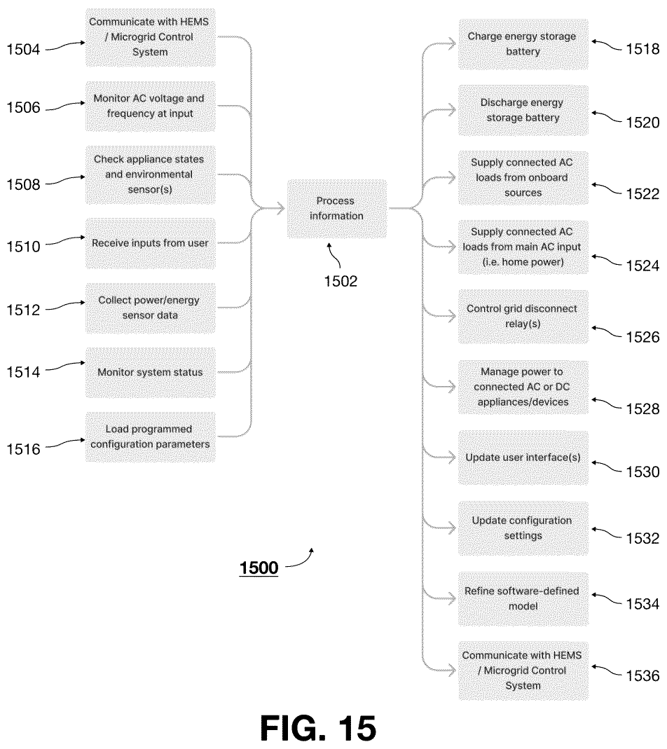

In scenarios involving a larger home microgrid with voltage and current sources provided by a combination of whole-home energy storage systems, solar PV, and/or standby generators, the system's Nanogrid Control System software seamlessly integrates and coordinates with the Microgrid Control System (MCS) and/or Home Energy Management System (HEMS) to optimize overall microgrid performance. FIG. 15 illustrates an example of the software functions 1500 executed by the system to enable intelligent energy management, microgrid coordination, and real-time control of power sources and loads.

At the input level, the system is designed to communicate with HEMS/Microgrid Control System 1504, ensuring interoperability and data exchange for coordinated energy management. It continuously monitors AC voltage and frequency at input 1506, assessing grid stability and identifying when to disconnect, modulate, or adjust power flows. To further enhance appliance-specific energy control, the system checks appliance states and environmental sensors 1508, allowing it to tailor energy delivery based on operational conditions. The system also receives inputs from the user 1510, enabling manual control over power settings, preferences, and operational modes.

For real-time power management and analytics, the system collects power/energy sensor data 1512, tracking consumption, energy storage levels, and load behavior. Additionally, it continuously monitors system status 1514, ensuring safe operation, fault detection, and performance optimization. To maintain configuration integrity, the system loads programmed configuration parameters 1516, applying predefined rules and logic to guide energy storage, load management, and grid interaction.

Upon processing this information 1502, the system executes various software-defined actions to optimize energy use. It actively charges the energy storage battery 1518 when excess power is available, whether from solar PV, the grid, or other energy sources. When needed, it discharges the energy storage battery 1520 to power connected loads or export energy to the microgrid. The system intelligently supplies connected AC loads from onboard sources 1522, ensuring backup power availability during outages or peak demand periods, and can alternatively supply connected AC loads from the main AC input (i.e., home power) 1524 when the grid is available and optimal for load supply.

A critical function of the system is to control grid disconnect relay(s) 1526, allowing it to island from the grid when necessary, ensuring seamless transitions between grid-tied and off-grid operation. Additionally, it manages power to connected AC or DC appliances/devices 1528, optimizing their performance, efficiency, and longevity through intelligent load prioritization.

User interaction and control interfaces are updated dynamically through the system's ability to update user interface(s) 1530, reflecting real-time energy data, appliance performance, and operational insights on local and remote interfaces. The system also ensures adaptability by updating configuration settings 1532, adjusting operational parameters based on new data, user preferences, or external control signals.

To continuously refine energy management strategies, the system refines software-defined models 1534, incorporating real-time operational data to enhance predictive algorithms and improve efficiency. Finally, it communicates with HEMS/Microgrid Control System 1536 to ensure coordinated energy dispatch, load balancing, and participation in larger-scale energy management strategies.

The NAAS system's EMS is designed with coordination capabilities, facilitating interaction with a utility grid via control signals provided by an aggregator, thereby providing direct control over Virtual Power Plant (VPP) and Demand Response (DR) functionalities to support grid stability. Through seamless communication, intelligent control, and predictive optimization, the system delivers advanced energy resilience and enhances the performance of modern microgrid ecosystems.

### Pairing the System With an Appliance

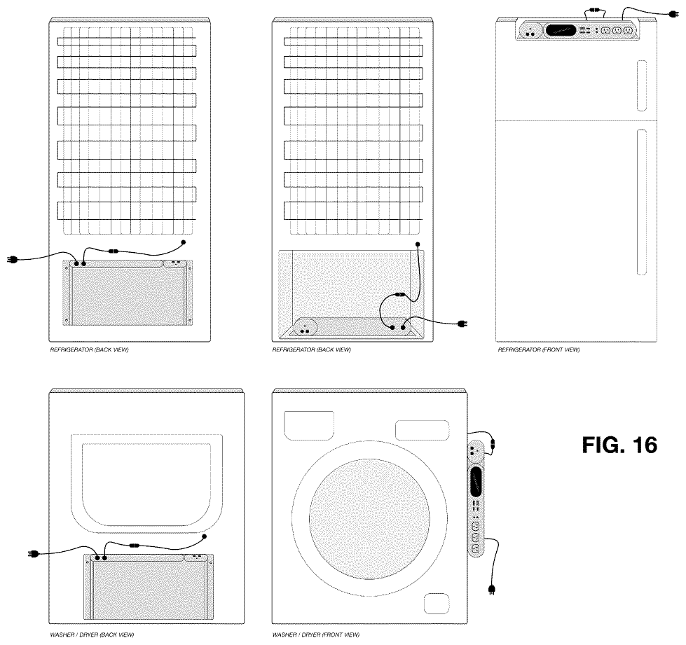

In some embodiments, as illustrated by FIG. 16, the system is designed for direct mechanical, electrical and digital coupling with specific home appliances. Note that the specific appliances depicted in FIG. 16 are provided only as examples. Modifications may be made to the pairing system, such as to the attachment locations on the appliance, attachment types (e.g., bolt, screw, magnetic coupling, rivets, welds, adhesives, dowel pins, snap fits, slots, etc.) and packaging form factor of the attaching nanogrid system. Integration of this style confers backup power, additional data insights, energy management, integration and participation with home or building and utility grid, while improving space efficiency and installation ease of the combined devices for users, while also enabling direct digital data exchange between the nanogrid system and appliance's native monitoring and control system.

In these embodiments designed for specific appliance coupling, the system is designed specifically for ease of attachment, removal and/or replacement, such as for service and repairs. This is achieved by thoughtful mounting location, touch-safe enclosure design, a system of electrical wire connectors, and a mechanical fastening technique that allows the system to be easily removed and restored.

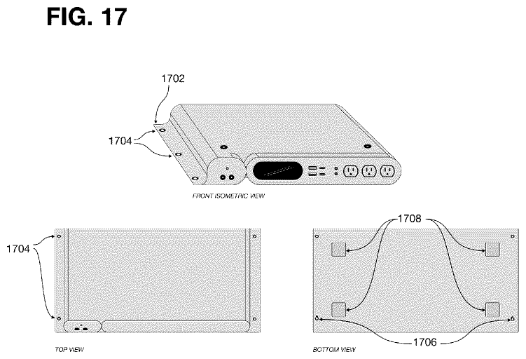

In these embodiments designed for specific appliance coupling, effective mechanical coupling with the appliance can be achieved by designing this system with a standard mounting hardware configuration to match mounting interfaces provided on the appliance, as shown in FIG. 17. In some embodiments, the location and sizing of the mounting hardware may be specific to different brands or models of appliance, for example, to attach with existing hardware of the appliance. In some embodiments, appliances will be designed with recesses or slots to accommodate nanogrid systems, for example, such that the nanogrid system can slide into and lock within an opening of the appliance enclosure providing physical and electrical connection. In some embodiments, a retrofit system may be attached to the appliance such as via semi-permanent adhesives or existing attachment locations of the appliance, with carriages or mounting systems (e.g., slotted, etc.) for the nanogrid system attached to the appliance.

In an embodiment such as depicted in FIG. 17, the system includes flanged surface(s) 1702 with through-hole mounting features 1704. In some embodiments, one or more keyhole mounting features 1706 are included in the design to facilitate installation and removal. The system is designed to allow operation in any x-y-z mounting orientation to allow flexible integration on the exterior chassis or within a home appliance. The mounting system includes provisions to reduce effects of noise, vibration, and mechanical shock while preserving robust physical attachment. In some embodiments this is achieved by a system of elastomeric (e.g. rubber) planes 1708 and/or washers integrated in between the appliance chassis and chassis of the nanogrid system.

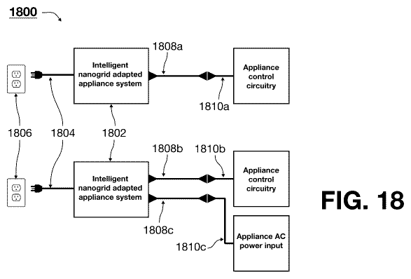

In these embodiments designed for specific appliance coupling, effective electrical coupling with the appliance is achieved by inclusion of one or more systems of electrical wiring harness(es) and connector(s) between the coupled appliance and nanogrid system, such as shown in FIG. 18. Such wiring harnesses are designed at minimum to provide electrical continuity between the AC input to the appliance (e.g. phase conductors, a neutral conductor, and a protective earth conductor) and the nanogrid device 1802 to which an AC power cord 1804 provides electrical connection to the building's power receptacle 1806. In some embodiments, the wiring harnesses are customized or retrofitted, for example, integrated into the appliance or within a carriage that attaches to the appliance. For example, the appliance connection or carriage may include a slot or slots (e.g., similar to a desktop peripheral slot such as PCI slots) at a location for slidably inserting or “snapping” a nanogrid system with electrical connectors (e.g., pins, communication lines, etc.) that slidably attach with the nanogrid system, with AC or other power connectors provided via the appliance or on an external-facing surface of the mounting hardware.

In an example, one 1808a or more 1808b-c connectorized wiring harness(es) exits the nanogrid system, pairing with one 1810a or more 1810b-c connectorized wiring harness(es) from the target appliance. In some embodiments, the electrical connection interface includes one or more DC power conductor pairs (e.g. 3.3 to 48 V DC). In some embodiments, the electrical connection interface includes conductors dedicated to communication between the onboard appliance control circuitry and the onboard compute module of the nanogrid system, using wired communication methods such as RS485, RS232, CAN bus, SPI, I2C, USB, or similar serial communication methods.

In these embodiments designed for specific appliance coupling, effective direct software communication with the appliance can be achieved by the aforementioned electrical wiring harness and/or wireless protocols, to gather data from integrated sensors within the appliance and/or via software integration with the appliance control unit. In these embodiments, communication may be bidirectional (e.g. between nanogrid compute system and the native appliance control system) or unidirectional (e.g. from the native appliance control system to the nanogrid compute system).

In some embodiments designed for specific appliance coupling, the remote unit module is extended to an accessible external location on or adjacent to the coupled appliance. In other embodiments of direct appliance coupling, the remote unit remains connected to the main unit in this application when accessibility of the remote unit interfaces is preserved. In yet other embodiments of direct appliance coupling, the remote unit module's componentry (e.g., auxiliary AC and DC receptacles are desired, and physical UI) is integrated with the housing of the coupled appliance. Data exchange provides the nanogrid system with real-time appliance state data, allows sending the appliance control signals (e.g. stop/start defrost cycles, start/stop internal heaters, start/stop motors compressors or fans, modify duty cycle(s), modify appliance setpoints for purposes of power management, perform energy optimization routines, and/or gather performance diagnostics). In some embodiments, local digital communication is achieved by taking advantage of API(s) hosted by the appliance and/or wireless standards for local appliance communication (e.g. OpenADR, TCP/IP REST API, Matter, etc.).

In these embodiments designed for specific appliance coupling environmental sensor modules may optionally be omitted when sensor information (e.g. temperature, humidity, appliance state) is provided from direct communication with the appliance control unit, from native sensors within the appliance.

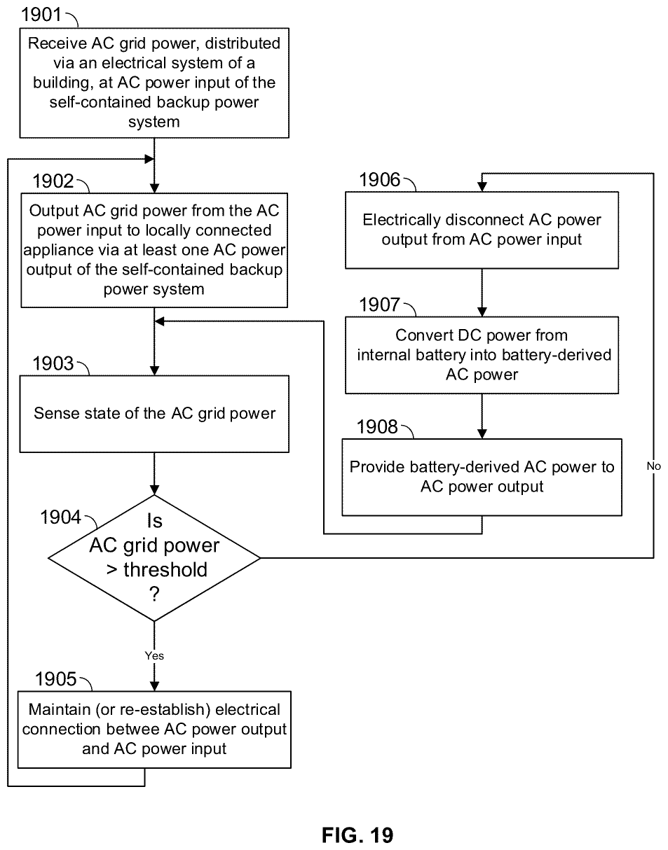

FIG. 19 is a flow chart illustrating an example of a process that may be performed by the system to provide AC power to a connected appliance under variable input power conditions. Initially, at step 1901 the system receives AC grid power, distributed via an electrical system of a building, at an AC power input (e.g., input 930 in FIG. 9a) of the system. At step 1902 the system outputs AC power to a locally connected appliance via at least one AC power output (e.g., output 926 in FIG. 9a) of a plurality of power outputs of the system. At step 1903 the system senses a state (e.g., a voltage) of the AC grid power. At step 1904 the system determines whether the state (e.g., voltage) of the AC grid power satisfies a specified condition (e.g., exceeds a specified threshold voltage).

If the state of the AC grid power satisfies the specified condition in step 1904, then the process proceeds to step 1905, in which the system maintains an electrical connection between the at least one AC power output and the AC power input. If, on the other hand, the state of the AC grid power does not satisfy the specified condition in step 1904, then the process instead proceeds from step 1904 to steps 1906 through 1908. In step 1906, the system electrically disconnects the at least one AC power output from the AC power input. In step 1907 the system converts DC power from an internal battery of the system (e.g., battery 914 in FIG. 9a) into battery-derived AC power. In step 1908 the system provides the battery-derived AC power produced in step 1907 to the at least one AC power output.

What is claimed is:

1. A backup power system comprising:
a power supply input configured to receive AC power distributed via an electrical system of a building;
a battery;
a plurality of power outputs;
a processing unit including at least one programmable processor and memory, configured to cause power to be provided to the plurality of power outputs from the battery or the power supply input selectively based on a status of the received AC power; and
an enclosure including the battery and the processing unit and at least partially including the power supply input and the plurality of power outputs.

2. The backup power system of claim 1, wherein the processing unit is configured to perform software-controlled selective electrical disconnection from, and reconnection to, a source of the AC power distributed via the electrical system of a building.

3. The backup power system of claim 1, further comprising a display device, wherein the processing unit is configured to cause the display device to display system status and to receive user inputs from a user.

4. The backup power system of claim 1, wherein the plurality of power outputs comprise at least one AC power output, the backup power system further comprising a power converter to convert DC power from the battery into AC power for the at least one AC power output.

5. The backup power system of claim 4, further comprising a shared DC bus located within the enclosure, to connect the battery and a plurality of other DC power sources to the power converter, to enable the power converter to convert DC power from any of the other DC power sources into AC power for the at least one AC power output.

6. The backup power system of claim 4, wherein the processing unit is configured to cause the AC power from the at least one AC power output to be disconnected from the at least one AC power output when the status of the received AC power indicates that the received AC power is less than a threshold value.

7. The backup power system of claim 4, wherein the at least one AC power output is configured to receive AC power from the electrical system of the building, the power converter via the onboard battery, or a combination thereof, in response to a software-controlled selection.

8. The backup power system of claim 4, wherein the power converter comprises a bidirectional power converter operable to convert AC power to DC power and to convert DC power to AC power.

9. The backup power system of claim 4, wherein the processing unit is further configured to cause the bidirectional power converter to operate in a hybrid grid-following mode when a first condition occurs and to operate in a grid following mode when a second condition occurs, according to one or more software-defined settings.

10. The backup power system of claim 1, wherein the enclosure comprises a main unit, the backup power system further comprising a remote unit external to the enclosure, wherein the remote unit includes a second plurality of power outputs and a user interface.

11. The backup power system of claim 10, wherein remote unit includes an attachment component for fixedly attaching the remote unit to a home appliance.

12. The backup power system of claim 11, wherein the attachment component comprises one or more magnets.

13. The backup power system of claim 1, further comprising a microgrid outlet configured to connect to a second backup power system including at least one of an additional battery energy storage system or a solar photovoltaic system, wherein the processing unit is configured to form a microgrid with the second backup power system when the backup power system is connected to the second backup power system.

14. The backup power system of claim 1, further comprising one or more sensors configured to measure the received AC power, and wherein the status of the received AC power is determined based on an output of the one or more sensors.

15. The backup power system of claim 1, further comprising at least one additional sensor, the at least one additional sensor comprising at least one of: temperature sensor, a light sensor, an appliance state sensor, or an air quality sensor.

16. The backup power system of claim 1, further comprising a DC power input within the enclosure, wherein the DC power input is configured to receive DC power from a solar panel or an expansion battery.

17. The backup power system of claim 1, further comprising a plurality of input/output ports and at least one external sensor attached to the input/output ports, wherein the processing unit is further configured to selectively cause the AC power to be provided based on an output from the at least one external sensor.

18. The backup power system of claim 1, further comprising a wireless communication interface located within the enclosure.

19. The backup power system of claim 18, wherein the processing unit is configured to cause information about the selectively providing the power to be transmitted to a user device via the wireless communication interface.

20. The backup power system of claim 18, wherein the processing unit is configured to receive information about a connected appliance via the wireless communication interface and to modify the selectively providing the power based on the received information.

21. The backup power system of claim 18, wherein the processing unit is configured to cause commands to be transmitted to a connected appliance via the wireless communication interface.

22. The backup power system of claim 18, wherein the power is selectively provided based on Energy Management System requirements.

23. The backup power system of claim 1, wherein the processing unit is configured to disconnect the AC power from the at least one AC power output when the status of the received AC power indicates that the AC power is greater than a threshold value.

24. The backup power system of claim 1, further comprising a disconnect circuitry coupled to the power supply input, wherein the processing unit is further configured to cause the disconnect circuitry to disconnect one or more of the plurality of power outputs from the received AC power based on the status of the AC power.

25. The backup power system of claim 24, wherein the disconnect circuitry comprises one or more relays.

26. The backup power system of claim 1, wherein the plurality of power outputs are touch-safe power outputs.

27. The backup power system of claim 1, further comprising a mechanical mounting system to attach the backup power control system to an appliance.

28. The backup power control system of claim 27, wherein attachment of the backup power control system to the appliance is based on preexisting locations of attachment components on the appliance, and wherein the enclosure and the mounting system are arranged to integrate with the preexisting locations of attachment components.

29. The backup power control system of claim 27, wherein attachment of the backup power control system to the appliance is based on the mounting system attaching to one or more preexisting attachment components of the appliance, wherein the mounting system comprises an additional attachment component to attach to the enclosure, and wherein the enclosure attaches to the mounting system.

30. The backup power control system of claim 27, wherein the enclosure comprises an integrated location for attachment of the enclosure to the appliance via the mounting system.

31. The backup power system of claim 30, wherein the integrated location comprises a slot or a recess.

32. The backup power control system of claim 27, further comprising one or more signal connectors through which to exchange signals with the appliance.

33. The backup power control system of claim 32, further comprising one or more power connectors through which to provide power to the appliance.

34. The backup power system of claim 1, wherein the processing unit is configured to:
receive over-the-air software updates, and updated settings via a smartphone application and web application; and
transmit information about the backup power system and connected devices to additional backup power systems via a wireless communication interface.

35. A backup power system comprising:
a power supply input configured to receive AC power distributed via an electrical system of a building;
a battery;
a plurality of touch-safe power outputs, including at least one AC power output;
a bidirectional power converter to convert a DC output from the battery into AC power for the at least one AC power output when operating in a first mode, and to convert the received AC power to DC power to charge the battery when operating in a second mode;
a first power relay coupled between the power supply input and the bidirectional power converter, to switchably connect or disconnect the at least one AC power output to a source of the AC power distributed via an electrical system of a building;
a second power relay coupled between the first power relay and the bidirectional power converter and between the bidirectional power converter and the at least one AC power output, to switchably connect or disconnect the bidirectional power converter to the at least one AC power output;
a shared DC bus to connect the battery and a plurality of other DC power sources to the bidirectional power converter, to enable the bidirectional power converter to convert a DC output from any of the other DC power sources into AC power for the at least one AC power output when operating in the first mode;
a processing unit configured to control the first power relay and the second power relay to
control a direction of power conversion to be performed by the bidirectional power converter based on a sensed condition,
selectively cause power to be provided to the plurality of power outputs from the battery or the power supply input based on a status of the received AC power, and
selectively cause electrical disconnection from, and reconnection to, a source of the AC power distributed via the electrical system of a building;
a display device to display status information of the backup power system in response to signals from the processing unit and to receive user inputs from a user; and
an enclosure including the battery, the bidirectional power converter, the processing unit and the shared DC bus, and at least partially including the power supply input.

36. A method of operating a self-contained backup power system, the method comprising:
receiving AC grid power, distributed via an electrical system of a building, at an AC power input of the self-contained backup power system;
outputting AC power to a locally connected appliance via at least one AC power output of a plurality of power outputs of the self-contained backup power system;
locally sensing, within the self-contained backup power system, a state of the AC grid power;
determining, within the self-contained backup power system, whether the state of the AC grid power satisfies a specified condition;
based on an outcome of the determining,
maintaining an electrical connection between the at least one AC power output and the AC power input when the state of the AC grid power satisfies the specified condition; and
when the state of the AC grid power does not satisfy the specified condition,
electrically disconnecting the at least one AC power output from the AC power input,
converting DC power from an internal battery of the self-contained backup power system into battery-derived AC power, and
providing the battery-derived AC power to the at least one AC power output.

37. The method of claim 36, further comprising:
converting the AC grid power received at the AC power input to DC power; and
routing the DC power to the internal battery of the self-contained backup power system to cause charging of the internal battery.

38. The method of claim 36, further comprising:
gathering data from the appliance, at the self-contained backup power system; and
tailoring distribution of AC power to the appliance, at the self-contained backup power system, based on the data gathered from the appliance.

39. The method of claim 36, further comprising:
displaying status information of the backup power system at a user interface; and
receiving, via the user interface, user inputs from a user, for use in controlling operation of the system.

40. The backup power system of claim 18, wherein the processing unit is configured to receive information about on-premises distributed energy resources, including solar photovoltaic systems and battery storage system, via the wireless communication interface and to modify the selectively providing the power based on the received information.

41. The backup power system of claim 18, wherein the processing unit is configured to receive information about on-premises distributed energy resources, including solar photovoltaic systems and battery storage systems, via the wireless communication interface and to modify a charge and discharge power of the battery.

42. The backup power system of claim 18, wherein the processing unit is configured to cause commands to be transmitted to connected on-premises distributed energy resources, including solar photovoltaic systems and battery storage systems, via the wireless communication interface.

43. The method of operating the self-contained backup power system of claim 36, wherein the method includes developing and repeatedly updating a statistical software model of connected appliances based on collected historical usage data, real-time load demand, and appliance operating parameters, and repeatedly using the statistical software model.

44. The method of claim 36, further comprising:
wirelessly transmitting data about the backup system via application programming interfaces (APIs) intended for third party access; and
tailoring distribution of AC power and DC power at the self-contained backup power system, based on data exchanged over API communication.
